(19) United States
(12) Patent Application Publication
(10) Pub. No.: US 2026/0002839 A1
(43) Pub. Date: Jan. 1, 2026

(54) DETECTION DEVICE, STATE DETECTION DEVICE, AND DETECTION METHOD

(71) Applicant: KABUSHIKI KAISHA TOKAI RIKA DENKI SEISAKUSHO, Aichi (JP)

(72) Inventor: Masanori KOSUGI, Aichi (JP)

(73) Assignee: KABUSHIKI KAISHA TOKAI RIKA DENKI SEISAKUSHO, Aichi (JP)

(21) Appl. No.: 18/997,634

(22) PCT Filed: Jul. 24, 2023
(86) PCT No.: PCT/JP2023/027020

§ 371 Date: Jan. 22, 2025

(30) Foreign Application Priority Data
Jul. 27, 2022 (JP) 2022-119486
Jul. 27, 2022 (JP) 2022-119487
Jul. 27, 2022 (JP) 2022-119488

(51) Int. Cl. G01M 17/013

(52) U.S. Cl. CPC G01M 17/013

(57) ABSTRACT

A sensor device includes: an acceleration sensor that rotates in conjunction with rotation of a nut that fastens a wheel hub to a wheel rim and detects an acceleration along a detection axis that intersects with a rotation axis of the wheel rim; and a signal processor that detects a fastening state of the nut based on the acceleration detected by the acceleration sensor.

### TECHNICAL FIELD

The present disclosure relates to a detection device, a state detection device, and a detection method.

### BACKGROUND ART

Japanese Patent Laying-Open No. 2005-329907 (PTL 1) discloses a detection

device that detects a mounting state of a tire (a nut for fastening a wheel rim) based on a detection value of a detector (G sensor) attached to the tire or the wheel rim.

### CITATION LIST

### Patent Literature

PTL 1: Japanese Patent Laying-Open No. 2005-329907.

### SUMMARY OF INVENTION

### Technical Problem

However, in a device that detects a mounting state of a tire (a fastening member that fastens a wheel rim), a technique for more easily detecting the mounting state of the tire (the fastening member that fastens a wheel rim) is desired.

The present disclosure has been made to solve the aforementioned problem, and an object of the present disclosure is to provide a detection device, a state detection device, and a detection method capable of easily detecting a mounting state of a fastening member that fastens a rotating body such as a wheel rim.

### Solution to Problem

A detection device according to a first aspect of the present disclosure includes: an acceleration detection unit that rotates in conjunction with rotation of a fastening member that fastens a fastened member to a rotating body, and detects an acceleration in at least one detection axis that intersects with a rotation axis of the rotating body; and a state detection unit that detects a fastening state of the fastening member based on the acceleration detected by the acceleration detection unit.

As described above, in the detection device according to the first aspect of the present disclosure, the fastening state of the fastening member is detected based on the acceleration detected by the acceleration detection unit. Thus, the fastening state of the fastening member can be detected based on the acceleration of the fastening member. In the present disclosure, the acceleration of the fastening member is determined based on a centrifugal acceleration of the rotating body and a rotation angle of the fastening member, and is not affected by the type, size and the like of the rotating body. Therefore, the fastening state of the fastening member can be detected regardless of the type, size or the like of the rotating body. Thus, it is possible to easily detect the fastening state of the fastening member.

A state detection device according to a second aspect of the present disclosure is a state detection device that detects a fastening state of a fastening member based on an acceleration detected by an acceleration detection unit that rotates in conjunction with rotation of the fastening member that fastens a fastened member to a rotating body, and includes: an acquisition unit that acquires information based on the acceleration in a detection axis that intersects with a rotation axis of the rotating body; and a fastening state detection unit that detects the fastening state of the fastening member based on the information acquired by the acquisition unit.

As described above, in the state detection device according to the second aspect of the present disclosure, the fastening state of the fastening member is detected based on the acceleration detected by the acceleration detection unit. Accordingly, it is possible to provide a state detection device capable of easily detecting the fastening state of the fastening member.

A detection method according to a third aspect of the present disclosure is a detection method of a detection device that includes an acceleration detection unit that rotates in conjunction with rotation of a fastening member that fastens a fastened member to a rotating body, and includes: detecting, by the acceleration detection unit, an acceleration in a detection axis that intersects with a rotation axis of the rotating body; and detecting a fastening state of the fastening member based on the acceleration detected by the acceleration detection unit.

As described above, in the detection method according to the third aspect of the present disclosure, the fastening state of the fastening member is detected based on the acceleration detected by the acceleration detection unit. Accordingly, it is possible to provide a detection method capable of easily detecting the fastening state of the fastening member.

### Advantageous Effects of Invention

According to the present disclosure, it is possible to easily detect the fastening state of a fastening member that fastens a rotating body such as a wheel rim.

### BRIEF DESCRIPTION OF DRAWINGS

FIG. 1 is a diagram illustrating a vehicle provided with a sensor device according to any one of first to fifth embodiments.

FIG. 2 is a cross-sectional view of a nut according to the first embodiment.

FIG. 3 is a diagram illustrating a configuration of a sensor device according to the first embodiment.

FIG. 4 is a functional block diagram of a signal processor according to the first embodiment.

FIG. 5 is a front view illustrating a configuration of a tire of a vehicle (in an initial state).

FIG. 6 is a diagram illustrating a relationship between a centrifugal acceleration and an X-axis acceleration and a Y-axis acceleration.

FIG. 7 is a graph illustrating a relationship between an acceleration and a rotation angle of a wheel rim when a centrifugal force is 0.

FIG. 8 is a graph illustrating a relationship between an acceleration and a rotation angle of the wheel rim when the centrifugal force is 3 G.

FIG. 9A is a diagram illustrating a relationship between an average acceleration and a sensor angle when the centrifugal force is 3 G.

FIG. 9B is a diagram illustrating a relationship between an average acceleration and a sensor angle when the centrifugal force is 10 G.

FIG. 10 is a flowchart illustrating a control flow of the sensor device according to the first embodiment.

FIG. 11 is a diagram illustrating a configuration of a sensor device according to the second embodiment.

FIG. 12 is a front view illustrating a configuration of a tire when the sensor device is rotated from the state illustrated in FIG. 5.

FIG. 13 is a diagram illustrating waveforms of an X-axis normalized value, a Y-axis normalized value, and a centrifugal acceleration as a first example.

FIG. 14 is a flowchart illustrating a processing flow of the sensor device according to the second embodiment.

FIG. 15 is a diagram for explaining that it is detected that the direction of the centrifugal acceleration is shifted due to the effect of the gravitational acceleration.

FIG. 16 is a diagram illustrating a configuration of a sensor device according to the third embodiment.

FIG. 17 is a diagram illustrating an angle θ2 in the rectangular coordinate system.

FIG. 18 is a flowchart illustrating a processing flow of the sensor device according to the third embodiment.

FIG. 19 is a diagram illustrating a configuration of a sensor device according to the fourth embodiment.

FIG. 20 is a diagram illustrating a relationship between an acceleration and a rotation angle of a wheel rim when the centrifugal force is 6 G.

FIG. 21 is a graph illustrating a relationship between an acceleration and a rotation angle of the wheel rim when the centrifugal force is 6 G and a nut is loosened.

FIG. 22A is a diagram illustrating a relationship between an average acceleration and a sensor angle when the centrifugal force is 6 G.

FIG. 22B is a diagram illustrating a relationship between an average acceleration and a sensor angle when the centrifugal force is 10 G.

FIG. 23 is a diagram illustrating waveforms of an X-axis normalized value, a Y-axis normalized value, and a centrifugal acceleration as a second example.

FIG. 24 is a diagram illustrating waveforms of an X-axis normalized value, a Y-axis normalized value, and an arctangent function.

FIG. 25 is a flowchart illustrating a processing flow of the sensor device according to the fourth embodiment.

FIG. 26 is a diagram illustrating a configuration of a sensor device according to the fifth embodiment.

FIG. 27 is a front view illustrating a configuration of a tire of a vehicle according to a fifth embodiment.

FIG. 28A is a first diagram illustrating a relationship between a centrifugal acceleration and an acceleration detected by the acceleration sensor.

FIG. 28B is a second diagram illustrating a relationship between a centrifugal acceleration and an acceleration detected by the acceleration sensor.

FIG. 29 is a functional block diagram of a signal processor according to the fifth embodiment.

FIG. 30 is a flowchart illustrating an example process executed by the signal processor according to the fifth embodiment.

FIG. 31 is a flowchart illustrating an initial value setting routine executed by a signal processor according to a first modification of the fifth embodiment.

FIG. 32 is a flowchart illustrating an example process executed by the signal processor according to the first modification of the fifth embodiment.

FIG. 33 is a side view illustrating a state in which a wheel rim is fastened to a wheel hub according to a third modification.

FIG. 34 is a cross-sectional view of a fastening member for a wheel rim according to a fourth modification.

FIG. 35 is a diagram illustrating a modification of FIG. 34.

FIG. 36 is a cross-sectional view of a fastening member equipped with a looseness detection device according to a comparative example.

FIG. 37 is a view illustrating a state in which a night cap is attached to a wheel nut according to a comparative example.

FIG. 38 is a view for explaining individual difference in shaft lengths of bolts.

FIG. 39 is a diagram illustrating a relationship between an average value of differences between an X-axis acceleration and a Y-axis acceleration for different centrifugal forces and a sensor angle according to a fifth modification of the first embodiment.

### DESCRIPTION OF EMBODIMENTS

Hereinafter, an embodiment of the present disclosure will be described in detail

with reference to the drawings. In the drawings, the same or corresponding parts are denoted by the same reference numerals, and the description thereof will not be repeated.

### First Embodiment

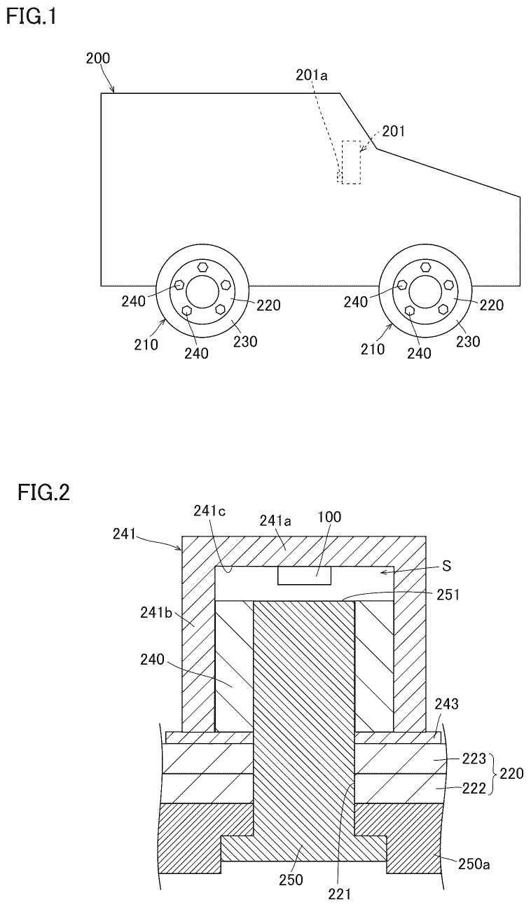

FIG. 1 is a diagram illustrating a vehicle 200 on which a sensor device 100 (see FIG. 2) according to a first embodiment is mounted. The vehicle 200 includes a plurality of wheels 210. In addition, the vehicle 200 includes a communication terminal 201 (multi-information display) that is capable of communicating with a communication unit 3 (to be described later) and includes a display unit (not illustrated). The sensor device 100 is an example of a “detection device” in the present disclosure.

The wheel 210 includes a wheel rim 220 and a tire 230 mounted on the wheel rim 220. The wheel rim 220 is fastened to a wheel hub 250a (see FIG. 2) by a plurality of (five in FIG. 1) nuts 240. The number of nuts 240 is not limited to the number mentioned above. The wheel hub 250a is an example of a “fastened member” and a “vehicle body” in the present disclosure. The wheel rim 220 is an example of a “rotating body” in the present disclosure, and each nut 240 is an example of a “fastening member” in the present disclosure.

As illustrated in FIG. 2, each nut 240 fastens a bolt 250 to the wheel rim 220. Specifically, the wheel rim 220 is provided with a plurality of (five) wheel holes 221, and the bolt 250 is inserted into (penetrates through) each wheel hole. Each nut 240 fastens the bolt 250 inserted into each wheel hole 221 to the wheel rim 220. The bolt 250 is fixed to the wheel hub 250a.

FIG. 2 illustrates a double tire as an example, and the wheel rim 220 is constituted by an inner wheel rim 222 and an outer wheel rim 223.

The nut 240 is open on one side. A nut cap 241 is attached to the nut 240. The sensor device 100 is attached to the nut cap 241, and thereby is indirectly provided in the nut 240. Therefore, the sensor device 100 rotates in conjunction with the rotation of the nut 240 (the nut cap 241).

Specifically, the nut cap 241 includes a top portion 241a and a side portion 241b. The side portion 241b is provided so as to circumferentially surround a portion of the bolt 250 passing through the wheel hole 221. The top portion 241a is provided to face a tip end 251 of the bolt 250 (in the insertion direction of the bolt 250). The top portion 241a is continuous with the side portion 241b. A washer 243 may be disposed between the nut 240 and the wheel rim 220.

The sensor device 100 is attached (adhered) to an inner surface 241c of the top portion 241a of the nut cap 241. Therefore, the sensor device 100 is disposed in a space S of the nut cap 241 in which the bolt 250 is accommodated.

The sensor device 100 is provided in some of the plurality of nuts 240 provided in each wheel 210. Note that the sensor device 100 may be provided in each of the plurality of nuts 240 provided in each wheel 210.

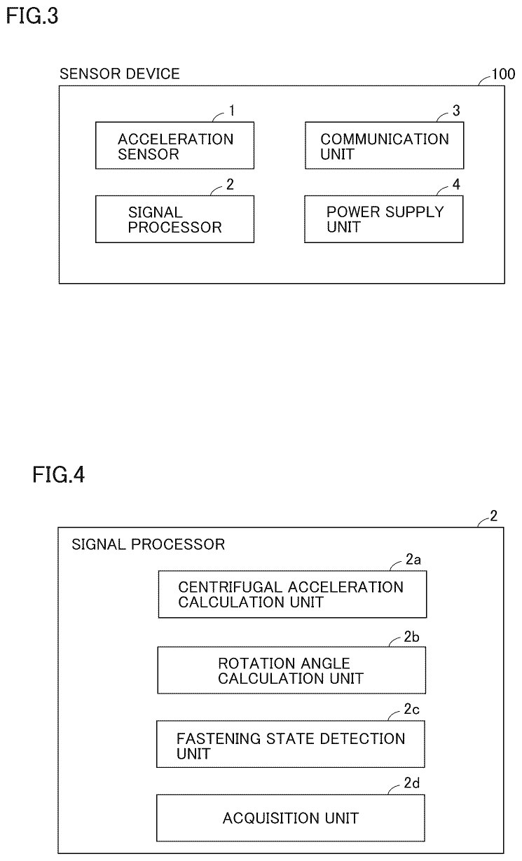

As illustrated in FIG. 3, the sensor device 100 includes an acceleration sensor 1, a signal processor 2, a communication unit 3, and a power supply unit 4. The acceleration sensor 1 is an example of an “acceleration detection unit” in the present disclosure. The signal processor 2 is an example of a “state detection unit” and a “state detection device” in the present disclosure.

As illustrated in FIG. 5, the acceleration sensor 1 detects an acceleration of each of an X-axis and a Y-axis which are orthogonal to each other in a plane orthogonal to a rotation axis O (not shown) of the wheel rim 220 which extends in a direction perpendicular to the paper surface of FIG. 5, i.e., a rotation axis of the wheel hub 250a. The acceleration detected by the acceleration sensor 1 has a positive or negative magnitude (direction). An arrow of the X axis and an arrow of the Y axis illustrated in FIG. 5 indicate a positive direction of the X axis and a positive direction of the Y axis, respectively. When viewing from the paper surface of FIG. 5, a direction of the Y axis when it is rotated counterclockwise by 90 degrees with respect to the X axis is referred to as a positive direction. The X axis is an example of a “first axis”, and the Y axis is an example of a “second axis” in the present disclosure.

The Z direction illustrated in FIG. 5 indicates the vertical direction (up-down direction). In the present embodiment, the nut 240 (the nut 240A) is fastened in such a manner that the positive direction of the X axis of the acceleration sensor 1 faces upward (Z1 direction) in an initial state (a state where the nut 240A is not loosened). Note that in the initial state, the positive direction of the X-axis of the acceleration sensor 1 may face a direction other than the Z1 direction. In FIG. 5, a nut 240 of the five nuts 240 that is located at the furthest position in the Z1 direction is referred to as a nut 240A. In the following description, when the sensor device 100 is oriented as that illustrated in FIG. 5, an angle (rotation angle) of the sensor device 100 is 0 degrees, and the direction in which the sensor device 100 is rotated clockwise is referred to as a positive rotation direction.

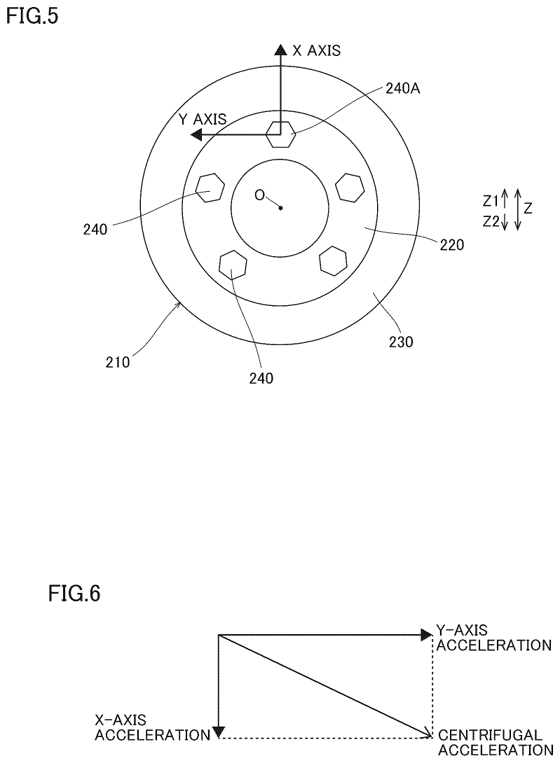

As illustrated in FIG. 6, the centrifugal acceleration applied to the nut 240A is divided into an X-axis acceleration and a Y-axis acceleration. In other words, the centrifugal acceleration is a vector sum of the X-axis acceleration and the Y-axis acceleration.

The signal processor 2 detects a state (fastening state) of the nut 240 based on a detection signal of the acceleration sensor 1. The signal processor 2 includes a centrifugal acceleration calculation unit 2a (see FIG. 4), a rotation angle calculation unit 2b (see FIG. 4), a fastening state detection unit 2c (see FIG. 4), and an acquisition unit 2d (see FIG. 4). Each of the centrifugal acceleration calculation unit 2a, the rotation angle calculation unit 2b, and the fastening state detection unit 2c illustrated in FIG. 4 represents software in which functional features of the signal processor 2 are divided into blocks. The acquisition unit 2d may be, for example, a terminal that receives a signal including information on a detection value detected by the acceleration sensor 1. The detail of each function will be described later.

In addition, the signal processor 2 acquires speed information of the vehicle 200 (a rotation speed of the wheel rim 220) from a processing unit (not illustrated) provided in the vehicle 200.

The communication unit 3 transmits a processing result of the signal processor 2 or information based on the processing result to the communication terminal 201 (see FIG. 1) of the vehicle 200 through wireless communication.

The power supply unit 4 supplies power to each of the acceleration sensor 1, the signal processor 2, and the communication unit 3. The acceleration sensor 1 detects an X-axis acceleration and a Y-axis acceleration every 100 to 200 ms (for example, every 150 ms). The power supply unit 4 is, for example, a lithium ion battery, and has a limited storage capacity of power. In order to reduce the power consumption of the signal processor 2, the acceleration detection or the like by the acceleration sensor 1 is not constantly performed, but is repeatedly performed every predetermined period.

The acceleration sensor 1 detects an X-axis acceleration (Xg) which is an acceleration (vector) of the X axis and a Y-axis acceleration (Yg) which is an acceleration (vector) of the Y axis. Each of the X-axis acceleration and the Y-axis acceleration is represented by a G value (for example, the gravitational acceleration is denoted as 1 G).

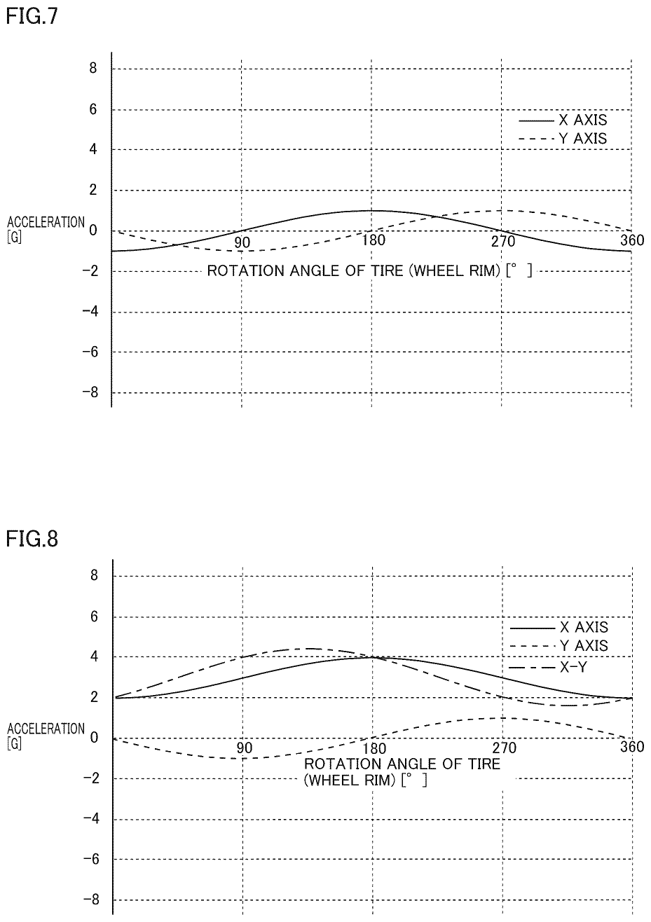

FIG. 7 is a graph illustrating a relationship between a rotation angle of the tire 230 (the wheel rim 220) and each of the X-axis acceleration and the Y-axis acceleration when the vehicle speed of the vehicle 200 is zero (i.e., the centrifugal force applied to the nut 240 is zero). In this case, each of the X-axis acceleration and the Y-axis acceleration fluctuates sinusoidally in a range of ±1 G. This is because each of the X axis and the Y axis includes only an acceleration component based on the gravitational acceleration in the Z2 direction. FIG. 7 illustrates a result of the sensor device 100 provided in the nut 240A illustrated in FIG. 5. Regarding the rotation angle of the tire, i.e., the horizontal axis in FIGS. 7 and 8, the direction along which the tire 230 as illustrated in FIG. 5 is rotated clockwise is defined as the positive direction.

FIG. 8 is a graph illustrating a relationship between a rotation angle of the tire 230 (the wheel rim 220) and each of the X-axis acceleration and the Y-axis acceleration when the vehicle is traveling at a predetermined speed and thereby a centrifugal force with a centrifugal acceleration of 3 G is applied to the nut 240. In the present disclosure, the magnitude of the centrifugal force may be indicated by the G value. When the Y axis is oriented as that illustrated in FIG. 5, the force component of the centrifugal force is not applied to the Y axis, and thereby the Y-axis acceleration is the same as that illustrated in FIG. 7. On the other hand, since the force component of the centrifugal force is applied to the X axis, the X-axis acceleration is equal to a value obtained by adding 3 G to the X-axis acceleration illustrated in FIG. 7. The waveform of a difference between the X-axis acceleration and the Y-axis acceleration (see the dash-dotted line in FIG. 7) is a sine wave that fluctuates in a range of 3 G±1.41 G. FIG. 8 is a diagram illustrating a result of the sensor device 100 provided in the nut 240A illustrated in FIG. 5.

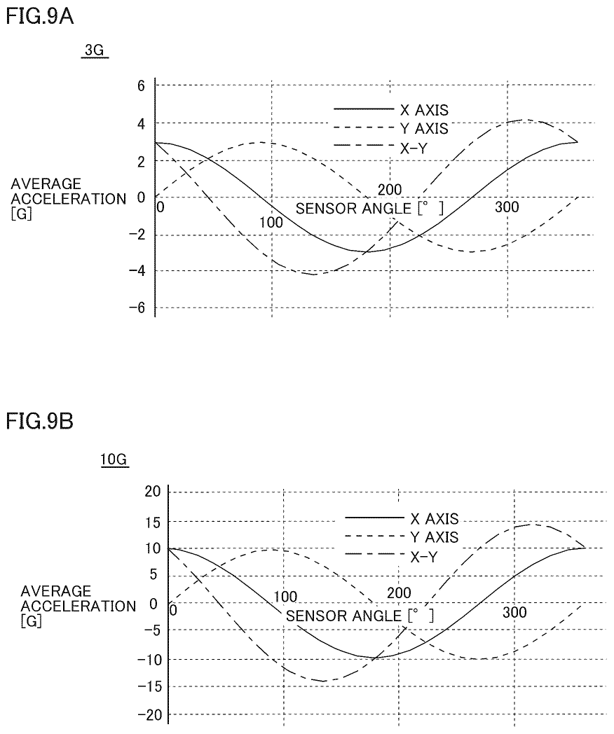

FIG. 9A is a graph illustrating an average acceleration with respect to an angle (rotation angle) of the sensor device 100 when the centrifugal force is 3 G. FIG. 9B is a graph illustrating an average acceleration with respect to an angle (rotation angle) of the sensor device 100 when the centrifugal force is 10 G. For example, a value of each waveform at each point where the sensor angle is 0 in FIG. 9A represents an average value of each waveform illustrated in FIG. 8. The average value in each of FIGS. 9A and 9B corresponds to one rotation period of the tire 230. However, in practice, as described above, in order to reduce the power consumption of the signal processor 2, it is desirable to repeatedly perform the sensing every predetermined period. When the vehicle speed is constant, the average value of results repeated for a plurality of times (for example, 50 times or more) is likely to be close to the average value of one rotation period of the tire 230.

As illustrated in FIGS. 9A and 9B, the waveform of the average value of each of the X-axis acceleration, the Y-axis acceleration and the difference between the X-axis acceleration and the Y-axis acceleration has an amplitude corresponding to the centrifugal force (the scales of the vertical axes are different from each other), but has the same shape. Therefore, it is possible to acquire the information on the rotation angle of the nut 240 (the sensor device 100) based on at least two of the X-axis acceleration, the Y-axis acceleration, and the difference between the X-axis acceleration and the Y-axis acceleration at an arbitrary time. Specific examples will be described below.

For example, assume that an X-axis acceleration (X-axis average acceleration to be described later), a Y-axis acceleration (Y-axis average acceleration to be described later), and a difference between the X-axis acceleration and the Y-axis acceleration (the X-axis average acceleration and the Y-axis average acceleration) are 0 G, 3 G, and −3 G, respectively. Further, assume that the signal processor 2 detects that a centrifugal force (centrifugal acceleration) applied to the sensor device 100 is 3 G based on the acquired vehicle speed information. In this case, the signal processor 2 detects that the angle (rotation angle) of the sensor device 100 is about 90 degrees based on the graph of FIG. 9A corresponding to the case where the centrifugal force is 3 G. Note that the term “about” is used to denote that each waveform in FIG. 9A indicates an average value of each acceleration. Specifically, each of the X-axis acceleration and the Y-axis acceleration may fluctuate within a range of ±1 G from the average value. The difference between the X-axis acceleration and the Y-axis acceleration may fluctuate within a range of ±1.41 G from the average value.

In other words, when the information on the rotation angle of the nut 240 (the sensor device 100) is acquired based on at least two of the X-axis acceleration, the Y-axis acceleration, and the difference between the X-axis acceleration and the Y-axis acceleration at an arbitrary time, a fluctuation range is included.

As described above, it is desirable to repeatedly perform the sensing every predetermined period in order to reduce the power consumption of the signal processor 2. By appropriately setting the repetition interval, it is possible to ignore or greatly reduce the fluctuation range (specifically, the fluctuation range of each of the X-axis acceleration and the Y-axis acceleration is ±1 G, and the fluctuation range of the difference between the X-axis acceleration and the Y-axis acceleration is ±1.41 G). As a result, it is possible to accurately determine the angle (rotation angle) of the sensor device 100.

Therefore, the signal processor 2 acquires information on the X-axis acceleration and the Y-axis acceleration in each sensing period (for example, 150 ms as described above) corresponding to one rotation period of the wheel rim 220. Note that in the sensing period, the information on acceleration detected by the acceleration sensor 1 is acquired twice during one rotation period of the wheel rim 220 (in this case, one rotation period is 300 ms). In other words, the information on acceleration is acquired every half rotation period of the wheel rim 220.

In the example described above, the X-axis acceleration, the Y-axis acceleration, and the difference between the X-axis acceleration and the Y-axis acceleration are 0 G, 3 G, and −3 G, respectively. When the acceleration information is acquired at an arbitrary time, the fluctuation range may be 0±1 G, 3±1 G, and −3±1.41 G, respectively, but when the acceleration information is acquired every half rotation period of the wheel rim 220, the fluctuation range is zero. For example, if the acceleration information is acquired at each of 90 degrees and 270 degrees in FIG. 8, the fluctuation range is zero (the fluctuation range may be ignored). Note that 90 degrees and 270 degrees are one condition for half rotation period of the wheel rim 220. The condition is satisfied as long as the difference between two angles is equal to 180 degrees. In other words, the acceleration may be acquired at two angles of 45 degrees and 225 degrees or at two angles of 60 degrees and 240 degrees.

FIG. 8 illustrates an example in which the sensor angle of FIG. 9A is 0 degrees (when the sensor device 100 is oriented as that illustrated in FIG. 5). Thus, the example will be described again with reference to FIG. 8 when the sensor angle is 0 degrees. With reference to FIG. 8, it is obvious that the X-axis acceleration, the Y-axis acceleration, and the difference between the X-axis acceleration and the Y-axis acceleration are 3±1 G, 0±1 G, and 3±1.41 G, respectively.

Assuming that acceleration information is acquired at the angle of 90 degrees in FIG. 8, the X-axis acceleration, the Y-axis acceleration, and the difference between the X-axis acceleration and the Y-axis acceleration are 3 G, −1 G, and 4 G, respectively. At the angle of 270 degrees, the X-axis acceleration, the Y-axis acceleration, and the difference are 3 G, 1 G, and 2 G, respectively. When the results at the two angles are averaged, the X-axis acceleration, the Y-axis acceleration, and the difference are 3 G, 0 G, and 3 G, respectively. This value is equal to the result of the case where the sensor angle in FIG. 9A is 0 degrees. In other words, the average value of one rotation period in FIG. 8 is equal to the average value of two accelerations, each of which is detected by the acceleration sensor 1 every half rotation period of the wheel rim 220.

The interval for every half rotation period of the wheel rim 220 may be appropriately set to reduce the power consumption of the signal processor 2. Specifically, the interval is the shortest detection time required by the acceleration sensor 1 to determine the sensor angle. By using this detection time, the sensor angle (the rotation angle of the nut 240) can be accurately determined.

The waveform data illustrated in FIGS. 9A and 9B may be stored in a storage device (not shown) for each centrifugal force that differs from each other (for each vehicle speed).

In the example described above, the signal processor 2 detects that the centrifugal force (centrifugal acceleration) applied to the sensor device 100 is 3 G based on the acquired vehicle speed information, and determines the angle (rotation angle) of the sensor device 100 based on the graph (see FIG. 9A) corresponding to the case where the centrifugal force is 3 G. However, if the vehicle speed information is not available, the angle cannot be determined based on the graph.

For example, only an X-axis acceleration sensor is exemplified. When the centrifugal force (centrifugal acceleration) is 3 G, the sensor angle determined from FIG. 9A is 0 degrees. On the other hand, when the centrifugal force (centrifugal acceleration) is 10 G, the sensor angle determined from FIG. 9A is about 70 degrees or 290 degrees. In other words, when the centrifugal force (the centrifugal acceleration, which is synonymous with the vehicle speed in this case) is not known, the calculated angle will be different, and thereby it will not be possible to determine whether or not the nut is loose. When the vehicle speed is not available, as to be described hereinafter, the sensor angle can be calculated by using a ratio of acceleration information (including the difference and other calculation results) for a plurality of axes even if the vehicle speed information is not available.

Comparing FIGS. 9A and 9B, the waveforms have the same shape, but the vertical scales are different from each other. When there is no change in the installation of the sensor device 100 (i.e., when there is no loosening), even if the centrifugal force applied to the sensor is different due to different vehicle speeds, the relationship between the average acceleration and the sensor angle will be similar as illustrated in FIGS. 9A and 9B.

This will be described in detail with reference to FIGS. 9A and 9B. In FIG. 9A, when the sensor angle is about 20 degrees (around an intersection point between the broken line and the dash-dotted line among the three lines), the X-axis acceleration, the Y-axis acceleration, and the difference between the X-axis acceleration and the Y-axis acceleration are 2.6 G, 1.3 G, and 1.3 G, respectively. In FIG. 9B, when the sensor angle is about 20 degrees, the X-axis acceleration, the Y-axis acceleration, and the difference between the X-axis acceleration and the Y-axis acceleration are 8.6 G, 4.3 G, and 4.3 G, respectively. It can be seen that each value in FIG. 9B is approximately 3.3 times the corresponding value in FIG. 9A, and the ratio is 2:1:1 for each figure. Even when the centrifugal force (i.e., the vehicle speed) is different, the ratio between the accelerations obtained by the sensor is the same. By using this ratio, the sensor angle (the rotation angle of the nut 240) can be calculated even if the vehicle speed information is not available.

The signal processor 2 (the fastening state detection unit 2c) detects the fastening state of the nut 240 based on a difference between a rotation angle of the nut 240 calculated at the current time and a previous rotation angle of the nut 240. If the difference is beyond a predetermined allowable range, the signal processor 2 (the fastening state detection unit 2d) determines that the nut 240 is loosened. In this case, the signal processor 2 notifies the communication terminal 201 (see FIG. 1) that the nut 240 is loosened through the communication unit 3 (see FIG. 3). This may cause the communication terminal 201 to display a warning on a display unit (not shown), or may cause the communication terminal 201 to issue a warning sound. On the other hand, if the difference is within the predetermined allowable range, the signal processor 2 (the fastening state detection unit 2c) determines that the nut 240 is fastened. In this case, the signal processor 2 does not notify the communication terminal 201. The previous rotation angle may be a rotation angle of the previous time, or may be an average value of rotation angles for several previous times including the previous time.

The signal processor 2 (the fastening state detection unit 2c) determines that the rotation of the wheel rim 220 (the tire 230) is stopped when each of the current detection value and the previous detection value which has a larger absolute value of the X-axis average acceleration and the Y-axis average acceleration calculated by the acceleration sensor is within a range of ±1 G. The previous detection value may be a detection value of a previous time, or may be an average value of detection values for several previous times including the previous time. It is possible to determine that the rotation of the wheel rim 220 (the tire 230) is stopped based on either the X-axis acceleration or the Y-axis acceleration. It is possible to determine that the rotation of the wheel rim 220 (the tire 230) is stopped when the current detection value of both the X-axis acceleration and the Y-axis acceleration and the previous detection value of both the X-axis acceleration and the Y-axis acceleration are both within the range of ±1 G.

The nut 240 may become loose in many cases when vibration or an external force is applied to the wheel rim 220 or the nut 240, such as a case where the wheel hub 250a (the wheel rim 220) is rotating while the vehicle 200 is traveling. When the vehicle 200 is stopped and the rotation of the wheel hub 250a (the wheel rim 220) is stopped, it is extremely rare that the nut 240 will become loose. Therefore, when it is determined that the rotation of the wheel rim 220 (the tire 230) is stopped, the signal processor 2 increases the sensing period (the predetermined period) of the sensor device 100 (for example, increases the sensing period to 30 minutes).

The signal processor 2 acquires information on an initial value of the rotation angle of the nut 240. The signal processor 2 acquires the initial value based on, for example, the pressing of a predetermined button 201a (see FIG. 1) of the communication terminal 201. Specifically, the signal processor 2 sets the rotation angle of the nut 240 as the initial value when the vehicle 200 starts traveling after the button is pressed (or after a predetermined time from the start of traveling). The button 201a is preferably pressed when, for example, the tire 230 (the wheel rim 220) is mounted on the wheel hub 250a and the nut 240 is fastened with a predetermined tightening torque. In addition, a button having the function of the button 201a described above may be provided in the sensor device 100. The communication unit 3 of the sensor device 100 may be capable of performing bidirectional communication with the ECU of the vehicle 200. In this case, the information on the initial value may be stored in the signal processor 2.

The signal processor 2 (the fastening state detection unit 2c) detects the fastening state of the nut 240 based on a difference between the current rotation angle of the nut 240 and the initial value. Specifically, when the difference is beyond a predetermined allowable range, the signal processor 2 (the fastening state detection unit 2c) determines that the nut 240 is loosened (not fastened). In this case, the signal processor 2 notifies the communication terminal 201 (see FIG. 1) that the nut 240 is loosened through the communication unit 3 (see FIG. 3). This may cause the communication terminal 201 to display a warning on a display unit (not shown), or may cause the communication terminal 201 to issue a warning sound.

The signal processor 2 may not acquire the initial value when the predetermined button 201a is pressed. For example, when it is detected that the vehicle 200 is stopped by the above-described method, the signal processor 2 may detect that the rotation angle of the nut 240 (in at least one wheel 210) has changed before and after the stop of the vehicle. In this case, the signal processor 2 sets the rotation angle of the nut 240 after the change (or an average value of rotation angles detected in a plurality of times after the change) as the initial value. This is because a change in the rotation angle before or after the stop of the vehicle means that the tire 230 has been replaced or the nut 240 has been retightened.

When information A indicating that the nut 240 has been rotated in the tightening direction is acquired, the signal processor 2 (the fastening state detection unit 2c) detects the fastening state of the nut 240 by ignoring (excluding) the information A. Specifically, the information A includes information indicating that the nut 240 has been rotated in the tightening direction by a predetermined angle or more (for example, 30 degrees or more).

Specifically, as described above, when the information indicating that the nut 240 has been rotated in the tightening direction by a predetermined angle or more is acquired and the information A indicating the nut 240 does not loosen for a predetermined time or more (for example, 10 minutes or more) is acquired, the signal processor 2 (the fastening state detection unit 2c) detects the fastening state of the nut 240 by ignoring the information A. The fact that the nut 240 does not loosen means that the difference between the calculated rotation angle and the previous rotation angle (or the initial value of the rotation angle) is within the predetermined allowable range.

More specifically, when information B indicating that the nut 240 has been rotated in the loosening direction by a rotation angle equal to the rotation angle in the tightening direction is acquired immediately after acquiring the information indicating that the nut 240 has been rotated in the tightening direction by the predetermined angle or more in a state where the nut 240 has not loosened for a predetermined time or more as described above, the signal processor 2 (the fastening state detection unit 2c) detects the fastening state of the nut 240 by ignoring the information A. In the present disclosure, the rotation angle equal to the rotation angle in the tightening direction may be in a range of ±X degrees (for example, 5 degrees) centered on the rotation angle in the tightening direction. Therefore, when information indicating that the nut 240 has been rotated in the loosening direction by a rotation angle (beyond the range) different from the rotation angle in the tightening direction is acquired, the signal processor 2 (the fastening state detection unit 2c) detects the fastening state of the nut 240 without ignoring the information A (taking into consideration the information A). Accordingly, it is possible to ignore a change in the detection value caused by acceleration or vibration of the vehicle 200.

### Control Flow of Sensor Device

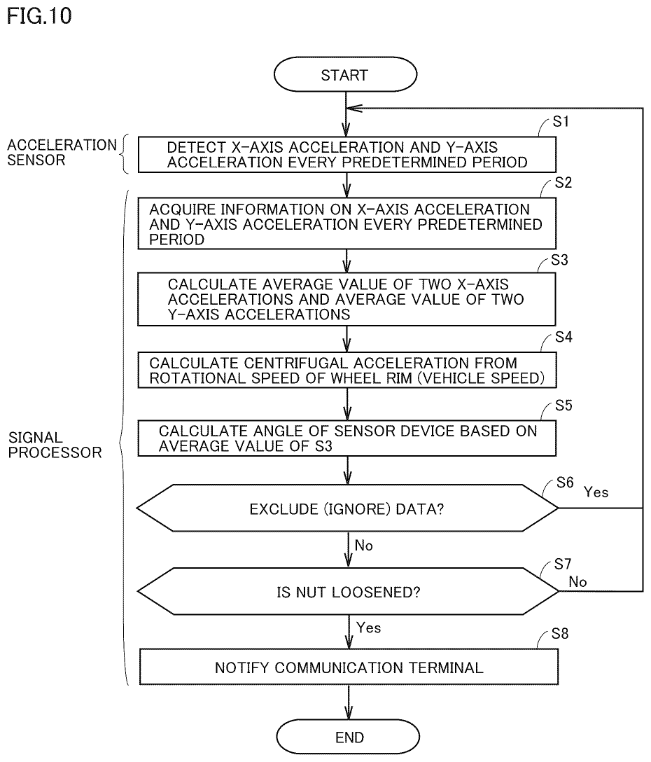

Next, a control flow of the sensor device 100 will be described with reference to FIG. 10. First, in step S1, the acceleration sensor 1 detects each of the X-axis acceleration and the Y-axis acceleration every predetermined period (for example, every 150 ms) set in advance.

Next, in step S2, the signal processor 2 acquires information on the X-axis acceleration and the Y-axis acceleration from the acceleration sensor 1. Specifically, the signal processor 2 acquires information on the X-axis acceleration and the Y-axis acceleration every predetermined period of step S1.

In step S3, the signal processor 2 calculates an average value (an X-axis average acceleration) of two X-axis accelerations, each of which is acquired in step S2 every predetermined period, and an average value (a Y-axis average acceleration) of two Y-axis accelerations, each of which is acquired in step S2 every predetermined period.

In step S4, the signal processor 2 (the centrifugal acceleration calculation unit 2a) calculates a centrifugal acceleration (a centrifugal force) of the wheel rim 220 from the rotational speed of the wheel rim 220 (the speed of the vehicle 200). Step S4 may be performed before or simultaneously with step S2 (or step S3).

In step S5, the signal processor 2 (the rotation angle calculation unit 2b) calculates the sensor angle of the sensor device 100 (the nut 240) based on the X-axis average acceleration and the Y-axis average acceleration calculated in step S3, and the centrifugal acceleration (centrifugal force) of the wheel rim 220.

In step S6, the signal processor 2 determines whether or not the data acquired in step S5 should be excluded (ignored) based on the sensor angle (rotation angle) of the sensor device 100 acquired in step S5. If it is determined that the data should be excluded (ignored) (Yes in S6), the procedure returns to step S1. If it is determined that the data should not be excluded (ignored) (No in S6), the procedure proceeds to step S7.

In step S6, as described above, when the information B indicating that the nut 240 has been rotated in the loosening direction by a rotation angle equal to the rotation angle in the tightening direction is acquired immediately after the information indicating that the nut 240 has been rotated in the tightening direction by the predetermined angle or more in a state where the nut 240 has not loosened for a predetermined time or more is acquired, it is determined that the data should be excluded (ignored).

In step S7, the signal processor 2 (the fastening state detection unit 2c) detects the fastening state of the nut 240 based on the sensor angle (rotation angle) of the sensor device 100 (the nut 240) calculated in step S5. When it is detected that the nut 240 is loosened (Yes in S7), the procedure proceeds to step S8. When it is detected that the nut 240 is not loosened (No in S7), the procedure returns to step S1. In step S7, as described above, the signal processor 2 (the fastening state detection unit 2c) may determine whether or not the nut 240 is loosened based on an amount of change (a difference) from a previous angle of the sensor device 100 or the initial value.

In step S8, the signal processor 2 notifies the communication terminal 201 that the nut 240 is loosened through the communication unit 3.

As described above, in the present embodiment, the rotation angle of the nut 240 is detected based on the X-axis acceleration, the Y-axis acceleration, and the rotation speed of the wheel rim 220 (the speed of the vehicle 200). Thus, even when the X-axis acceleration and the Y-axis acceleration fluctuate due to the rotation speed of the wheel rim 220, the rotation angle of the nut 240 can be easily detected based on the magnitude of the centrifugal force that can be calculated from the rotation speed of the wheel rim 220.

### Second Embodiment

In a second embodiment, the fastening state of the nut 240 is detected based on a ratio between the X-axis acceleration and the Y-axis acceleration. The same components as those in the first embodiment are denoted by the same reference numerals, and the description thereof will not be repeated.

FIG. 11 is a diagram illustrating a configuration of a sensor device 300 according to the second embodiment. The sensor device 300 is an example of a “detection device” in the present disclosure.

The sensor device 300 includes an acceleration sensor 1, a signal processor 12, a communication unit 3, and a power supply unit 4. The signal processor 12 is an example of a “state detection unit” and a “state detection device” in the present disclosure.

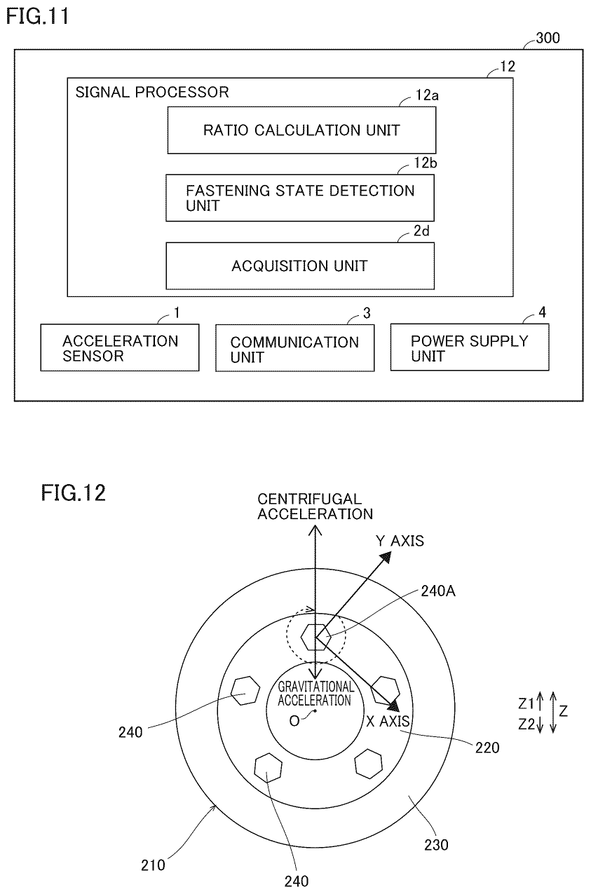

The signal processor 12 detects a state (fastening state) of the nut 240 (see FIG. 12) based on a detection signal of the acceleration sensor 1. The signal processor 12 includes a ratio calculation unit 12a, a fastening state detection unit 12b, and an acquisition unit 2d. Each of the ratio calculation unit 12a and the fastening state detection unit 12b represents software in which functional features of the signal processor 12 are divided into blocks. The detail of each function will be described later.

Similar to the signal processor 2 described in the first embodiment, the signal processor 12 calculates an average value (X-axis average acceleration and Y-axis average acceleration) of each of the X-axis accelerations and the Y-axis accelerations detected twice during one rotation period of the wheel rim 220.

The signal processor 12 (the ratio calculation unit 12a) calculates a ratio between the calculated X-axis average acceleration (hereinafter may be simply referred to as the X-axis acceleration) and the calculated Y-axis average acceleration (hereinafter may be simply referred to as the Y-axis acceleration). In other words, the signal processor 12 (the ratio calculation unit 12a) calculates the ratio every time when the X-axis acceleration and the Y-axis acceleration are acquired twice from the acceleration sensor 1. Specifically, the signal processor 12 (the ratio calculation unit 12a) calculates a value (|X|/|Y|) obtained by dividing the absolute value of the X-axis acceleration (X-axis average acceleration) by the absolute value of the Y-axis acceleration (Y-axis average acceleration). The ratio described above is an example of an “acceleration index” in the present disclosure.

The ratio may be a value obtained by dividing the absolute value of the Y-axis acceleration by the absolute value of the X-axis acceleration (|Y|/|X|). The ratio may be a value obtained by dividing the X-axis acceleration (Y-axis acceleration) by a root sum square of the X-axis acceleration and the Y-axis acceleration.

In the second embodiment, the signal processor 12 (the fastening state detection unit 12b) detects the fastening state of the nut 240A based on the calculated ratio. Specifically, the signal processor 12 (the fastening state detection unit 12b) detects the fastening state of the nut 240A based on a difference between a current ratio and a previous ratio. The detail will be described later.

For example, the previously calculated X-axis (average) acceleration and the previously calculated Y-axis (average) acceleration are −4 G and 10 G, respectively. In this case, the signal processor 12 (the ratio calculation unit 12a) calculates the ratio as about 0.4 (hereinafter, abbreviated as 0.4).

Next, the currently calculated X-axis (average) acceleration and the currently calculated Y-axis (average) acceleration are −4 G and 7 G, respectively, due to the change in the rotation angle of the nut 240A. In this case, the signal processor 12 (the ratio calculation unit 12a) calculates the ratio as about 0.57 (hereinafter, abbreviated as 0.57).

The signal processor 12 (the fastening state detection unit 12b) determines that the fastening state of the nut 240A has changed when (the absolute value of) an amount of change in the ratio is equal to or greater than a predetermined threshold value. Assuming that the predetermined threshold value is 0.1, for example, and when the ratio has changed from 0.4 to 0.57, it is determined that the fastening state of the nut 240A has changed.

As another example, the X-axis acceleration and the Y-axis acceleration have changed from −4 G and 10 G to −8 G and 20 G, respectively, because the centrifugal acceleration has increased but the rotation angle of the nut 240A does not change. In this case, the ratio before the change in the centrifugal acceleration and the ratio after the change in the centrifugal acceleration are equal to each other at 0.4. Since the amount of change in the ratio is less than the predetermined threshold value, the signal processor 12 (the fastening state detection unit 12b) determines that the fastening state of the nut 240A has not changed.

In addition, when the X-axis acceleration and the Y-axis acceleration have changed from 1 G and 11 G to 1 G and 1000 G, respectively, for example, the amount of change in the ratio (|X|/|Y|) becomes less than 0.1. On the other hand, when the X-axis acceleration and the Y-axis acceleration have changed from 11 G and 1 G to 1000 G and 1 G, respectively, for example, the amount of change in the ratio becomes 0.1 or more. As described above, even when the amounts of change in the rotation angle of the nut 240A in the two patterns are substantially equal to each other, the determination result of the fastening state of the nut 240A may be different.

Therefore, the signal processor 12 (the fastening state detection unit 12b) may change the magnitude of the predetermined threshold value based on the magnitude of the ratio. For example, when the ratio before the rotation angle of the nut 240A is changed is 0.1 or less, the predetermined threshold value may be set to one half of the ratio before the rotation angle is changed, or may be set to a predetermined fixed value (for example, 0.05) less than 0.1. Note that the above-described example in which the predetermined threshold value is changed is merely an example, and the present disclosure is not limited to the above-described example.

When the Y-axis acceleration is 0, the signal processor 12 (the ratio calculation unit 12a) calculates the ratio by replacing the Y-axis acceleration with a value approximate to 0 (for example, 0.01). When the signal processor 12 (the ratio calculation unit 12a) calculates the ratio by dividing the Y-axis acceleration by the X-axis acceleration, if the X-axis acceleration is 0, the signal processor 12 calculates the ratio by replacing the X-axis acceleration with a value approximate to 0. However, when the signal processor 12 (the ratio calculation unit 12a) calculates the ratio by dividing the X-axis acceleration or the Y-axis acceleration by the root sum square of the X-axis acceleration and the Y-axis acceleration, since the root sum square will never be equal to 0, the above-described approximation process is unnecessary.

It has been described above that the process is performed based on a difference between the previous ratio and the current ratio, the process may be performed based on a difference between the current ratio and an average value of several previous ratios including the previous ratio.

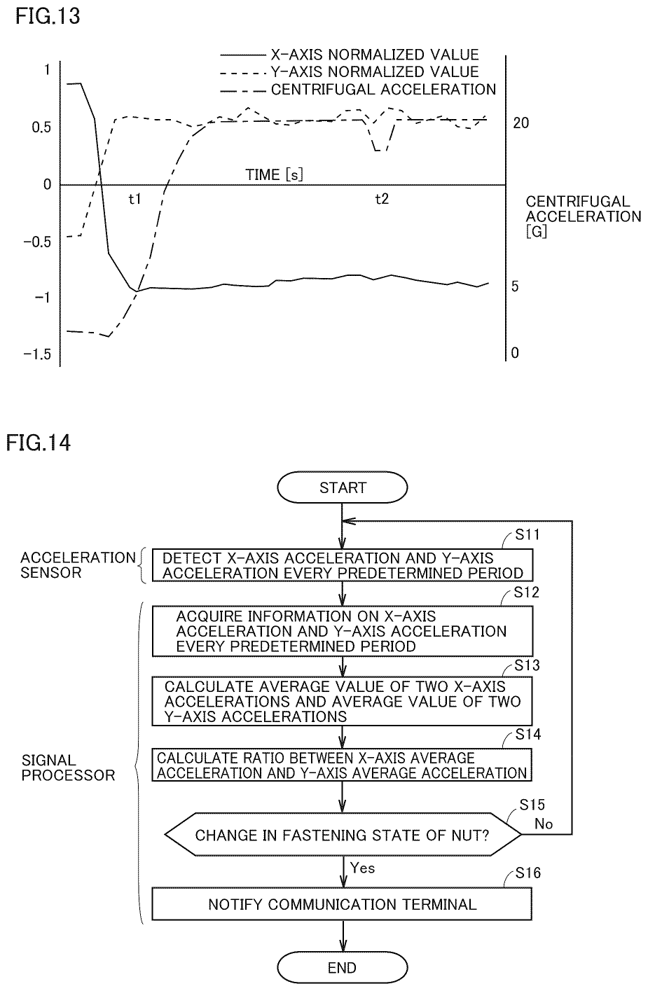

FIG. 13 is a graph illustrating changes in an X-axis normalized value (which is obtained by dividing the X-axis acceleration by the root sum square and is denoted by a solid line), a Y-axis normalized value (which is obtained by dividing the Y-axis acceleration by the root sum square and is denoted by a broken line), and a centrifugal acceleration (which is denoted by a dash-dotted line) over time. Each of the X-axis normalized value and the Y-axis normalized value is related to the left vertical axis. The centrifugal acceleration is related to the right vertical axis.

As illustrated in FIG. 13, until the centrifugal acceleration is about 5 G (around time t1), the amount of change in each of the X-axis normalized value and the Y-axis normalized value is relatively large, and after time t1, each of the X-axis normalized value and the Y-axis normalized value becomes relatively stable. Therefore, when the centrifugal acceleration is small, the amount of change in each of the X-axis normalized value (X-axis acceleration) and the Y-axis normalized value (Y-axis acceleration) is large. Therefore, as described above, it is effective to detect the fastening state of the nut 240 based on each of the X-axis average acceleration and the Y-axis average acceleration.

In addition, the signal processor 12 detects the fastening state of the nut 240 by ignoring the X-axis acceleration and the Y-axis acceleration obtained when the centrifugal acceleration of the wheel rim 220 changes rapidly (for example, around time t2). A rapid change in the centrifugal acceleration is often caused by sudden braking or the like of the vehicle 200. Therefore, it is possible to ignore a rapid change in the centrifugal acceleration due to factors other than the loosening of the nut 240. The rapid change in the centrifugal acceleration means that the absolute value of the rate of change in the centrifugal acceleration is equal to or greater than a predetermined value (such as 2 G/sec).

### Processing Flow of Sensor Device

Next, a processing flow of the sensor device 300 will be described with reference to FIG. 14. Since steps S11 to S13 are the same as steps S1 to S3 (see FIG. 10) in the first embodiment, the description thereof will not be repeated.

In step S14, the signal processor 12 (the ratio calculation unit 12a) calculates a ratio (|X|/|Y|) between the X-axis acceleration (X-axis average acceleration) and the Y-axis acceleration (Y-axis average acceleration).

In step S15, the signal processor 12 (the fastening state detection unit 12b) detects a change in the fastening state of the nut 240 based on the ratio calculated in step S14. When it is detected that the fastening state of the nut 240 has changed (Yes in S15), the procedure proceeds to step S16. When it is detected that the fastening state of the nut 240 has not changed (No in S15), the procedure returns to step S11. In step S15, similar to the first embodiment, the signal processor 12 (the fastening state detection unit 12b) detects a change in the fastening state of the nut 240 based on an amount of change (a difference) from a previous ratio or the initial value.

In step S16, the signal processor 12 notifies the communication terminal 201 that the nut 240 is loosened through the communication unit 3.

As described above, in the second embodiment, the fastening state of the nut 240 is detected based on a ratio between the X-axis acceleration and the Y-axis acceleration. Thus, the fastening state of the nut 240 can be detected without considering the change in the vehicle speed (centrifugal force).

The other components are the same as those described in the first embodiment, and the description thereof will not be repeated.

### Third Embodiment

Next, a third embodiment will be described. Different from the second embodiment in which the fastening state of the nut 240 is detected based on a difference in the ratio between the X-axis acceleration and the Y-axis acceleration, in the third embodiment, the fastening state of the nut 240 is detected based on a difference in the inverse trigonometric function value calculated based on the ratio. In the third embodiment, the same components as those in the first and second embodiments are denoted by the same reference numerals as those in the first and second embodiments, and the description thereof will not be repeated.

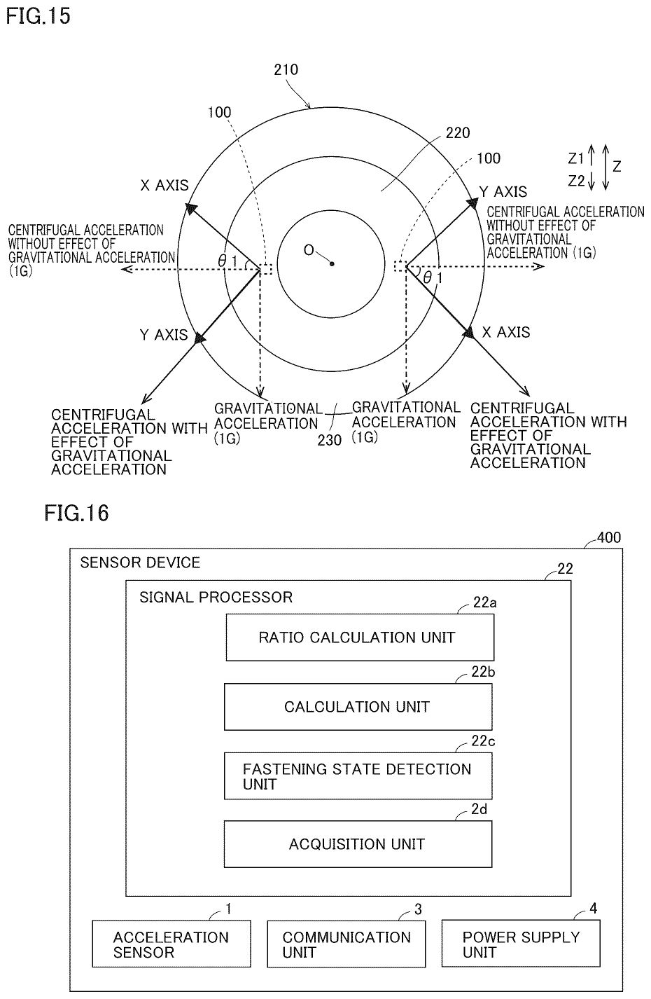

With reference to FIG. 15, the detection of the fastening state of the nut 240 based on an inverse trigonometric function value calculated based on the ratio between the X-axis acceleration and the Y-axis acceleration will be described. As illustrated in FIG. 15, a case in which acceleration information is acquired when the sensor device 100 is located at each of the 3 o'clock position and the 9 o'clock position will be described. Further, it is assumed that the direction of the centrifugal acceleration is located at the center between the X-axis direction and the Y-axis direction.

Since each of the X-axis acceleration and the Y-axis acceleration has a magnitude based on the centrifugal acceleration and the gravitational acceleration, when the centrifugal acceleration is sufficiently larger than the gravitational acceleration, the effect of the gravitational acceleration is small. Thus, assuming that when the centrifugal acceleration is 1 G and there is no effect of the gravitational acceleration, each of the X-axis acceleration and the Y-axis acceleration is 0.707 G. In this case, the angle θ1 formed by the direction of the centrifugal acceleration with respect to the X axis and the X axis is 45 degrees. Although any inverse trigonometric function may be used (the detail of the inverse trigonometric function will be described later), for the sake of clarity, the value of the inverse trigonometric function calculated based on the ratio between the X-axis acceleration and the Y-axis acceleration is θ1.

On the other hand, in practice, when the centrifugal acceleration is 1 G (i.e., when the centrifugal acceleration is equal to the gravitational acceleration), the gravitational force affects the detection of the acceleration. When the centrifugal acceleration is 1 G, the magnitude of the X-axis acceleration and the magnitude of the Y-axis acceleration deviate from the above-described value (0.707 G) due to the effect of the gravitational acceleration.

Specifically, the X-axis acceleration and the Y-axis acceleration detected by the acceleration sensor 1 of the sensor device 100 located at the 3 o'clock position are 1.414 G and 0 G, respectively. As a result, the angle θ1 is 0 degrees, which results in a 45-degree gap from the angle θ1 (45 degrees) when the gravity is ignored, resulting in an angular error.

On the other hand, the X-axis acceleration and the Y-axis acceleration detected by the acceleration sensor 1 of the sensor device 100 located at the 9 o'clock position are 0 G and 1.414 G, respectively. As a result, the angle 01 is determined to be −90 degrees, which has a 45-degree difference from the angle θ1 (−45 degrees) when the gravity is ignored, resulting in an angle error.

The present embodiment is characterized in that the fastening state of the nut 240 is detected based on a difference of the inverse trigonometric function value calculated based on the ratio. As described above, when the angle formed by the direction of the centrifugal acceleration with respect to the X axis and the X axis is the value (θ1) of the inverse trigonometric function calculated based on the ratio between the X axis acceleration and the Y axis acceleration, the difference (angle difference) contributes to the detection of the fastening state of the nut 240.

As described above, at the 3 o'clock position, there is a 45-degree difference from the angle θ1 (45 degrees) when the gravity is ignored, and at the 9 o'clock position, there is a 45-degree difference from the angle θ1 (−45 degrees) when the gravity is ignored. However, the effect of the gravity is cancelled by averaging the two angles.

In the above example, the effect of the gravity is canceled by averaging the angle θ1 calculated at the 3 o'clock position and the angle θ1 calculated at the 9 o'clock position. As in the first embodiment, the same effect can be obtained by averaging the detection values of the acceleration sensor 1 at the 3 o'clock position and at the 9 o'clock position. This will be described in more detail hereinafter.

In the present embodiment, the average value of the X-axis accelerations (X-axis average acceleration) and the average value of the Y-axis accelerations (Y-axis average acceleration) calculated at each of the 3 o'clock position and the 9 o'clock position in consideration of the effect of the gravity are 0.707 G and 0.707 G, respectively. In other words, each of the X-axis average acceleration and the Y-axis average acceleration is equal to the acceleration without the effect of the gravity. In other words, the detection deviation at each position due to the gravitational acceleration is canceled. As a result, even when the difference between the centrifugal acceleration and the gravitational acceleration is not large, the rotation angle (the fastened state) of the nut 240 can be accurately detected by averaging the two accelerations as described above. It is also acceptable to calculate the average value of the rotation angle of the nut 240 corresponding to the 3 o'clock position and the rotation angle of the nut 240 corresponding to the 9 o'clock position.

There is a difference between the method of obtaining angles by an inverse trigonometric function from the values acquired by the acceleration sensors at two points which are point-symmetrical with respect to the center (the rotation axis O) such as the 3 o'clock position and the 9 o'clock position and then obtaining an average thereof, and the method of obtaining an angle by an inverse trigonometric function from the average value of the values acquired by the acceleration sensors at two points. If the centrifugal force (i.e., the vehicle speed) is the same when the acceleration sensors acquire the values at two points, the results of the above two methods are the same. On the other hand, if the centrifugal force (the vehicle speed) is different from each other when the acceleration sensors acquire the values at two points, the method of obtaining an angle by an inverse trigonometric function from the values acquired by the acceleration sensors at two points and then obtaining an average thereof is more effective in reducing the effect of the gravity. In the first embodiment, when the vehicle speed is different at two points every half lap of the tire 230, the centrifugal force generated at the two points is different. This causes a problem when calculating the angle based on FIGS. 9A and 9B and the like. In particular, when the difference in vehicle speed is large, the angle calculation itself cannot be performed. On the other hand, as described in the method of the present embodiment, since the angles are calculated and then averaged, the above-described problem will not occur.

When the centrifugal acceleration of the wheel rim 220 is equal to or greater than a predetermined value (e.g., 1 G), the signal processor 2 detects the fastening state of the nut 240. The acceleration sensor 1 detects the X-axis acceleration and the Y-axis acceleration for each period based on the rotation speed (the vehicle speed) of the wheel rim 220 corresponding to the predetermined value (i.e., the minimum value). Specifically, when the centrifugal acceleration is equal to the predetermined value, the wheel rim 220 rotates one cycle in 300 ms. In this case, the acceleration sensor 1 detects the X-axis acceleration and the Y-axis acceleration at a period of 150 ms, which is one-half of 300 ms. The information on the period is stored in a memory (not shown) or the like of the sensor device 100.

The period of 150 ms is determined in advance by experiments, simulations, or the like in the manufacturing stage. For example, the period may be calculated based on a pitch circle diameter (PCD) of the bolt 250 to which the nut cap 241 is attached and a tire diameter.

In addition, a difference between a time when the sensor device 100 passes through the 6 o'clock position and a time when the sensor device passes through the 12 o'clock position may be defined as the period mentioned above. Since the direction of the gravity and the direction of the centrifugal force are the same at each of the 6 o'clock position and the 12 o'clock position, the angle error as described above does not occur. Accordingly, it is possible to accurately calculate the half rotation period of the wheel rim 220. The signal processor 2 may calculate the rotation period of the wheel rim 220 in real time based on the centrifugal acceleration (the vehicle speed) and the like, and change the period of acquiring the acceleration (the period for the acceleration sensor 1 to detect the acceleration) in accordance with a change in the rotation period.

As described above, the period of detecting the acceleration is set based on the minimum value of the centrifugal acceleration (the rotation speed of the wheel rim 220). As a result, as compared with the case where the rotation speed of the wheel rim 220 is greater, it is possible to prevent the wheel rim 220 from rotating nearly one full cycle during the period of detecting the acceleration. As a result, the signal processor 2 can easily acquire information on accelerations at two points (i.e., two positions that are point-symmetrical with respect to the rotation axis O): the 3 o'clock position with respect to the rotation axis O of the wheel rim 220 and the 9 o'clock position with respect to the rotation axis O. In other words, it is possible to prevent the acceleration from being detected at two points both on the side of the 3 o'clock position (or the 9 o'clock position). The accelerations may be acquired at two points of the 6 o'clock position and the 12 o'clock position, and since the direction of the gravity and the direction of the centrifugal force are the same at the two points, the above-described angle error does not occur. The reason why the minimum value of the centrifugal acceleration is used as a reference is because the effect of the gravity is greatest when the centrifugal acceleration is minimum. Even if the period of acquiring the acceleration is a fixed period, when the vehicle speed is sufficiently large and the centrifugal acceleration is also sufficiently large, the effect of the gravity becomes relatively small (and thereby the effect on the sensor angle is small) even when the two points at which the acceleration is detected are both on the side of the 3 o'clock position (or the 9 o'clock position).

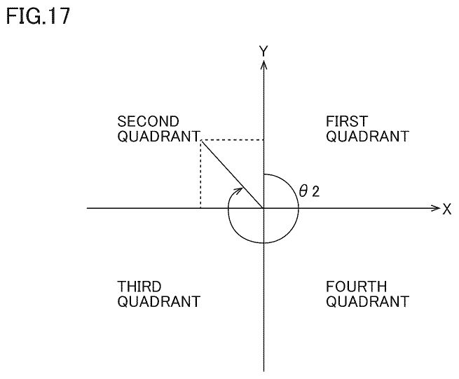

FIG. 16 is a diagram illustrating a configuration of a sensor device 400 according to a third embodiment. The sensor device 400 is an example of a “detection device” in the present disclosure.

The sensor device 400 includes an acceleration sensor 1, a signal processor 22, a communication unit 3, and a power supply unit 4. The signal processor 22 is an example of a “state detection unit” and a “state detection device” in the present disclosure.

As illustrated in FIG. 16, the signal processor 22 of the sensor device 400 includes a ratio calculation unit 22a, an angle calculation unit 22b, a fastening state detection unit 22c, and an acquisition unit 2d. Each of the ratio calculation unit 22a, the angle calculation unit 22b, and the fastening state detection unit 22c represents software in which functional features of the signal processor 22 are divided into blocks.

The signal processor 22 (the ratio calculation unit 22a) calculates a ratio (X/Y) between the X-axis acceleration and the Y-axis acceleration. The ratio may be a value (Y/X) obtained by dividing the Y-axis acceleration by the X-axis acceleration. The ratio may be a value obtained by dividing the X-axis acceleration (Y-axis acceleration) by the root sum square.

The signal processor 22 (the angle calculation unit 22b) calculates an inverse trigonometric function value (an arctangent function value: arctan (X/Y)) of the calculated ratio. The arctangent function value is an example of an “acceleration index” in the present disclosure. In the above description, the angle θ1 formed between the direction of the centrifugal acceleration with respect to the X axis and the X axis is calculated as an inverse trigonometric function value calculated based on the ratio between the X axis acceleration and the Y axis acceleration, but the angle θ1 may be calculated based on the arctangent function value as described above.

The arctangent function value is a value expressed by −90 degrees to 90 degrees. On the other hand, the rotation angle of the nut 240 is expressed by 0 to 360 degrees in the rectangular coordinate system (see FIG. 17). Therefore, in the third embodiment, the arctangent function value is converted into an angle in the rectangular coordinate system.

Specifically, the signal processor 22 (the angle calculation unit 22b) calculates an angle θ2 (see FIG. 15) by adding a predetermined value (an angle) to the arctangent function value. At this time, the signal processor 22 (the angle calculation unit 22b) changes the predetermined value based on the positive or negative sign of each of the X-axis acceleration (X-axis average acceleration) and the Y-axis acceleration (Y-axis average acceleration). Specifically, the signal processor 22 (the angle calculation unit 22b) determines the predetermined value depending on whether the combination of the X-axis acceleration and the Y-axis acceleration is a combination of a positive X-axis acceleration and a positive Y-axis acceleration, a combination of a positive X-axis acceleration and a negative Y-axis acceleration negative, a combination of a negative X-axis acceleration and a positive Y-axis acceleration, or a combination of a negative X-axis acceleration and a negative Y-axis acceleration.

For example, when the X-axis acceleration and the Y-axis acceleration are 4 G and 10 G, respectively (in the first quadrant of FIG. 17), the signal processor 22 (the angle calculation unit 22b) adds 0 to the arctangent function value (arctan(4/10)˜21.8) (in other words, nothing is added). In this case, the angle θ2 is about 21.8 degrees.

When the X-axis acceleration and the Y-axis acceleration are −4 G and 10 G, respectively (in the second quadrant of FIG. 17), the signal processor 22 (the angle calculation unit 22b) adds 360 to the arctangent function value (arctan (−4/10)˜−21.8). In this case, the angle θ2 is about 338.2 degrees.

When the X-axis acceleration and the Y-axis acceleration are −4 G and −10 G, respectively (in the third quadrant of FIG. 17), the signal processor 22 (the angle calculation unit 22b) adds 180 to the arctangent function value (arctan(−4/−10)˜21.8). In this case, the angle θ2 is about 201.8 degrees.

When the X-axis acceleration and the Y-axis acceleration are 4 G and −10 G, respectively (in the fourth quadrant of FIG. 17), the signal processor 22 (the angle calculation unit 22b) adds 180 to the arctangent function value (arctan(4/−10)˜−21.8). In this case, the angle θ2 is about 158.2 degrees.

As described above, by adding 0, 180, or 360 for each positive or negative sign (quadrant) of the X-axis acceleration and the Y-axis acceleration, it is possible to detect the fastening state of the nut 240A based on the rectangular coordinate system in which the angle increases clockwise from the positive Y-axis as the starting point (θ2=0).

As described above, when the X-axis acceleration and the Y-axis acceleration are −4 G and 10 G, respectively, the angle θ is about 338.2 degrees. When the X-axis acceleration and the Y-axis acceleration become −4 G and 7 G, respectively, due to the rotation of the nut 240A, the angle θ is about 330.3 degrees. Therefore, the angle θ decreases by about 7.9 degrees due to the rotation of the nut 240A.

In the present embodiment, the angle θ2 is an angle (see the broken line arrow in FIG. 12) between the (positive) Y axis and the direction of the centrifugal acceleration. Since the direction of the centrifugal acceleration is constant in the radial direction (outer diameter direction), the angle θ2 becomes smaller because the Y axis and the X axis (in other words, the sensor device 300) are rotated clockwise by about 7.9 degrees. As described above, the rotation direction and the rotation angle of the sensor device 300 (the nut 240A) can be detected based on a change in the angle θ2.

Similar to the second embodiment, the fastening state of the nut 240A may be detected based on a previous value or an initial value of the angle θ2.

In addition, similar to the first embodiment, when the information A indicating that the nut 240 is rotated in the tightening direction is acquired, the signal processor 22 (the fastening state detection unit 22c) detects the fastening state of the nut 240 by ignoring (excluding) the information A.

### Processing Flow of Sensor Device

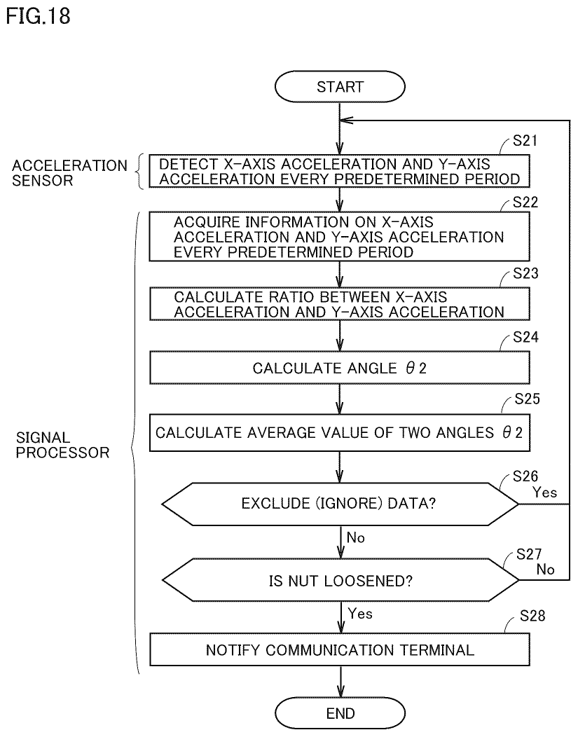

Next, a processing flow of the sensor device 400 will be described with reference to FIG. 18. Since steps S21 and S22 are the same as steps S11 and S12 (see FIG. 14) in the second embodiment, the description thereof will not be repeated.

In step S23, the signal processor 22 (the ratio calculation unit 22a) calculates a ratio (X/Y) between the X-axis acceleration (X-axis average acceleration) and the Y-axis acceleration (Y-axis average acceleration).

In step S24, the signal processor 22 (the angle calculation unit 22b) calculates the angle θ2 by adding 0, 180, or 360 to the arctangent function value of the ratio calculated in step S23. Specifically, the signal processor 22 (the angle calculation unit 22b) changes the value (0, 180, or 360) to be added based on the positive or negative sign of each of the X-axis acceleration (X-axis average acceleration) and the Y-axis acceleration (Y-axis average acceleration). Specifically, the signal processor 22 (the angle calculation unit 22b) changes the value (0, 180, or 360) to be added depending on whether the combination of the X-axis acceleration and the Y-axis acceleration is a combination of a positive X-axis acceleration and a positive Y-axis acceleration, a combination of a positive X-axis acceleration and a negative Y-axis acceleration negative, a combination of a negative X-axis acceleration and a positive Y-axis acceleration, or a combination of a negative X-axis acceleration and a negative Y-axis acceleration.

In step S25, an average value of two angles θ2, each of which is acquired in step S24 every predetermined period, is calculated.

Next, in step S26, the signal processor 22 determines whether or not the data acquired in step S25 should be excluded (ignored) based on the angle θ2 acquired in step S25. If it is determined that the data should be excluded (ignored) (Yes in S26), the procedure returns to step S21. If it is determined that the data should not be excluded (ignored) (No in S26), the procedure proceeds to step S27.

As described above, in step S26, it is determined that the data should be excluded (ignored) when information B indicating that the nut 240 has been rotated in the loosening direction by a rotation angle equal to the rotation angle in the tightening direction is acquired immediately after acquiring the information indicating that the nut 240 has been rotated in the tightening direction by the predetermined angle or more in a state where the nut 240 has not loosened for a predetermined time or more as described above. Similar to the second embodiment, in step S26, when the centrifugal acceleration of the wheel rim 220 is less than a predetermined value and the data is obtained when the centrifugal acceleration suddenly changes, it may be determined that the data should be excluded (ignored).

In step S27, the signal processor 22 (the fastening state detection unit 22c) detects the fastening state of the nut 240 based on the angle θ2 (average value) calculated in step S25. If it is detected that the nut 240 is loosened (Yes in S27), the procedure proceeds to step S28. If it is detected that the nut 240 is not loosened (No in S27), the procedure returns to step S21. In step S27, the signal processor 22 (the fastening state detection unit 22c) determines whether or not the nut 240 is loosened based on an amount of change (difference) from a previous value or an initial value of the angle θ2, as described above. Step S28 is the same as step S16 in the second embodiment.

As described above, in the third embodiment, the fastening state of the nut 240 is detected based on the arctangent function value of the ratio between the X-axis acceleration and the Y-axis acceleration. Although different from the second embodiment, it is possible to detect the rotation direction and the rotation angle of the nut 240.

### Fourth Embodiment

Next, a fourth embodiment will be described. Different from the third embodiment in which the fastening state of the nut 240 is detected based on an inverse trigonometric function value of the ratio between the X-axis acceleration and the Y-axis acceleration, in the fourth embodiment, the fastening state of the nut 240 is detected based on an X-axis normalized value obtained by normalizing the X-axis acceleration and a Y-axis normalized value obtained by normalizing the Y-axis acceleration. In the fourth embodiment, the same components as those in the first to third embodiments are denoted by the same reference numerals as those in the first to third embodiments, and the description thereof will not be repeated.

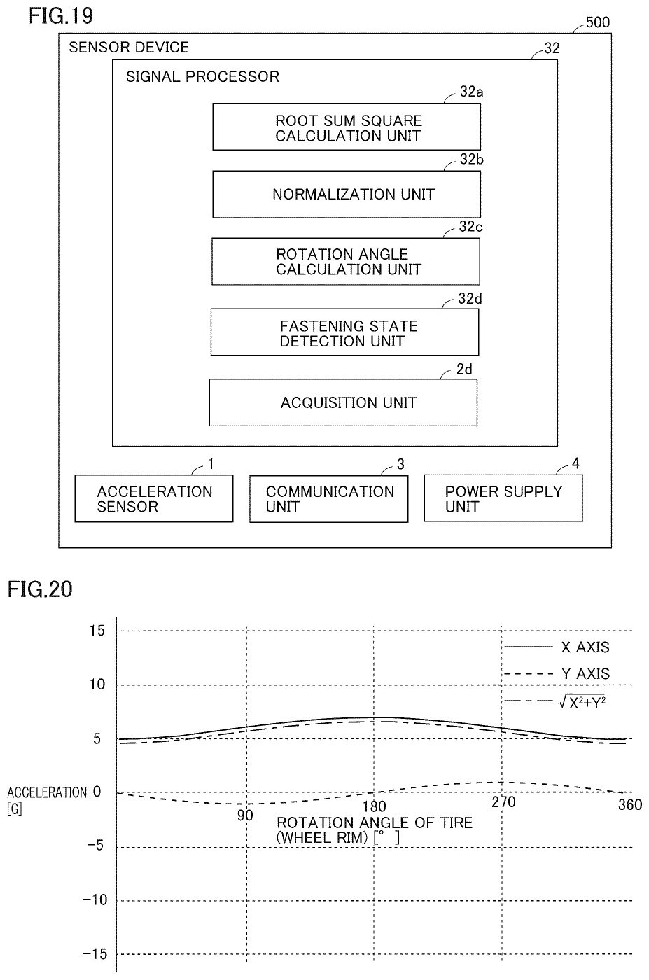

As illustrated in FIG. 19, the sensor device 500 includes an acceleration sensor 1, a signal processor 32, a communication unit 3, and a power supply unit 4. The signal processor 32 is an example of a “state detection unit” and a “state detection device” in the present disclosure.

The signal processor 32 includes a root sum square calculation unit 32a, a normalization unit 32b, a rotation angle calculation unit 32c, a fastening state detection unit 32d, and an acquisition unit 2d. Each of the root sum square calculation unit 32a, the normalization unit 32b, the rotation angle calculation unit 32c, and the fastening state detection unit 32d illustrated in FIG. 19 represents software in which functional features of the signal processor 32 are divided into blocks. The detail of each function will be described later.

In the fourth embodiment, the nut 240 (the nut 240A) is fastened in such a manner that the positive direction of the X axis of the acceleration sensor 1 faces upward (Z1 direction) in an initial state (a state where the nut 240A is not loosened) (see FIG. 5). Note that in the initial state, the positive direction of the X-axis of the acceleration sensor 1 may face a direction other than the Z1 direction. In the following description, when the sensor device 500 is oriented as that illustrated in FIG. 5, the angle (rotation angle) of the sensor device 500 is 0 degrees.

FIG. 20 is a graph illustrating a relationship between a rotation angle of the tire 230 (the wheel rim 220) and each of the X-axis acceleration and the Y-axis acceleration when the vehicle is traveling at a predetermined speed and thereby a centrifugal force with a centrifugal acceleration of 6 G is applied to the nut 240. Since the force component of the centrifugal force is not applied to the Y-axis in the direction of the Y-axis illustrated in FIG. 19, the Y-axis acceleration is the same as that in FIG. 7. On the other hand, since the force component of the centrifugal force is applied to the X axis, the X axis acceleration is equal to a value obtained by adding 6 G to the X axis acceleration in FIG. 7. In this case, the waveform of the root sum square of the X-axis acceleration and the Y-axis acceleration is the same as the waveform of the X-axis acceleration. In FIG. 20, for easy understanding, the waveform of the X-axis acceleration and the waveform of the root sum square of squares are slightly shifted from each other. FIG. 20 is a diagram illustrating a result of the sensor device 500 provided in the nut 240A illustrated in FIG. 5.

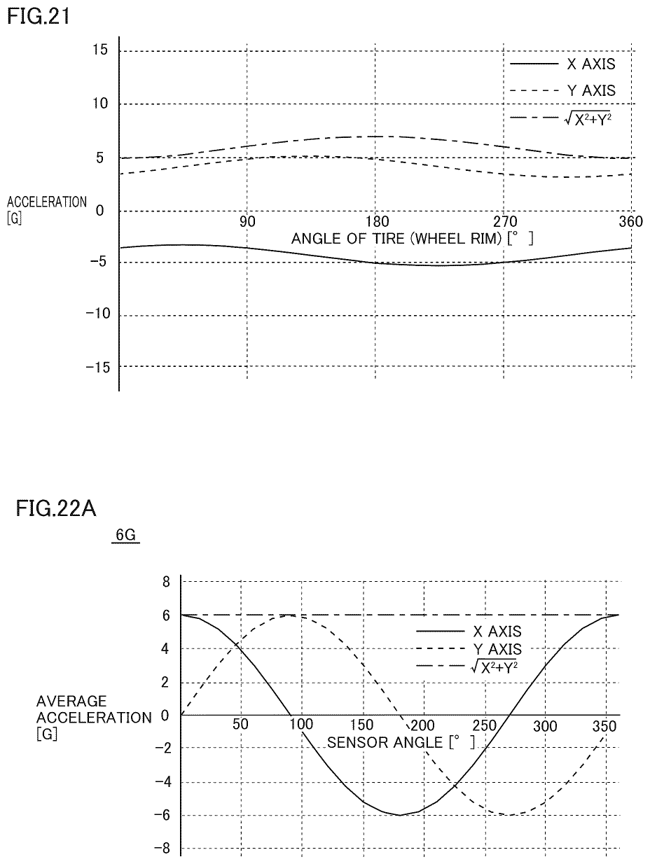

FIG. 21 is a graph illustrating the relationship between an angle of the tire 230 (the wheel rim 220) and each of the X-axis acceleration and the Y-axis acceleration when a centrifugal force of 6 G is applied to the nut 240 in a state (see FIG. 12) in which the nut 240A is rotated by 135 degrees in the clockwise direction (loosened by 225 degrees in the counterclockwise direction) from the state of FIG. 5. In this case, the amplitude of the waveform of each of the X-axis acceleration and the Y-axis acceleration is equal to that in the case of FIG. 20, the average value of each of the X-axis acceleration and the Y-axis acceleration is different from that in the case of FIG. 20. The average value of each of the X-axis acceleration and the Y-axis acceleration reflects the rotation angle of the nut 240 (the sensor device 500). On the other hand, the waveform of the root sum square of the X-axis acceleration and the Y-axis acceleration is the same as that in the case of FIG. 20, and does not change depending on the rotation angle of the nut 240 (the sensor device 400). FIG. 21 is a diagram illustrating a result of the sensor device 500 provided in the nut 240A illustrated in FIG. 20.

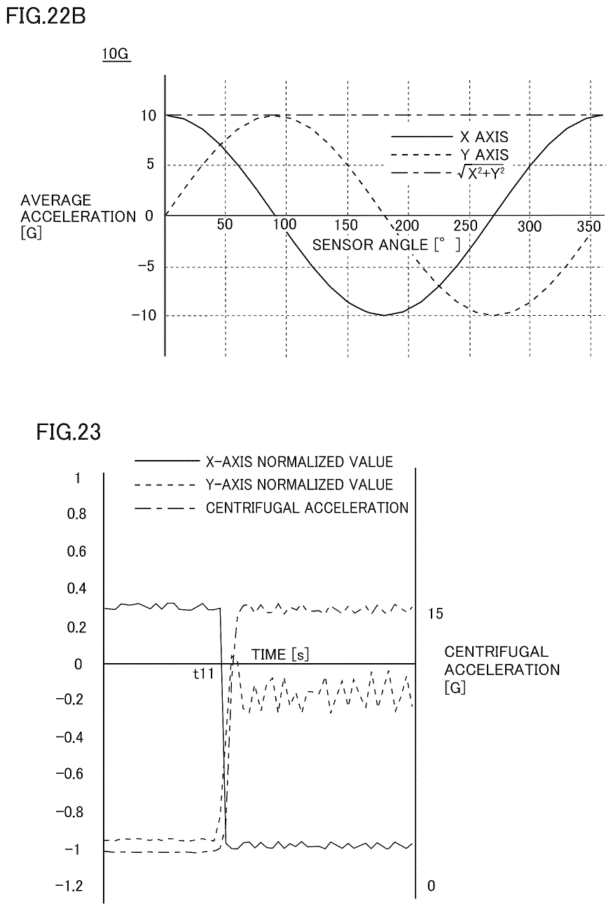

FIG. 22A is a graph illustrating an average acceleration with respect to an angle (rotation angle) of the sensor device 500 when the centrifugal force is 6 G. FIG. 22B is a graph illustrating an average acceleration with respect to an angle (rotation angle) of the sensor device 500 when the centrifugal force is 10 G. As illustrated in FIGS. 22A and 22B, the waveform of the X-axis average acceleration and the waveform of the Y-axis average acceleration have an amplitude corresponding to the centrifugal force (the scales of the vertical axes are different from each other), but have the same shape. In each of FIGS. 22A and 22B, the root sum square of the X-axis average acceleration and the Y-axis average acceleration is a constant value corresponding to the centrifugal force. Therefore, a value obtained by dividing the X-axis average acceleration by the root sum square and a value obtained by dividing the Y-axis average acceleration by the root sum square are equal to each other regardless of the magnitude of the centrifugal force.

The signal processor 32 (square sum square root calculation unit 32a) according to the fourth embodiment calculates the root sum square of the X-axis acceleration (Xg) (X-axis average acceleration) and the Y-axis acceleration (Yg) (Y-axis average acceleration). The signal processor 32 (the normalization unit 32b) calculates an X-axis normalized value by dividing the X-axis acceleration (X-axis average acceleration) by the root sum square. The signal processor 32 (the normalization unit 32b) calculates a Y-axis normalized value by dividing the Y-axis acceleration (Y-axis average acceleration) by the root sum square. The X-axis normalized value is an example of a “first axis normalized value”, and the Y-axis normalized value is an example of a “second axis normalized value” in the present disclosure. Each of the X-axis normalized value and the Y-axis normalized value is an example of an “acceleration index” in the present disclosure.

Then, the signal processor 32 (the rotation angle calculation unit 32c) calculates the rotation angle of the nut 240 (the sensor device 500) based on both of the X-axis normalized value and the Y-axis normalized value. As described above with reference to FIGS. 22A and 22B, when the vehicle speed is equal to or greater than a predetermined value, the X-axis normalized value and the Y-axis normalized value depend on the sensor angle regardless of the centrifugal force (the vehicle speed). Therefore, by using the X-axis normalized value and the Y-axis normalized value, it is possible to determine the rotation angle of the nut 240 regardless of the vehicle speed.

FIG. 23 is a graph illustrating changes in the X-axis normalized value (the solid line), the Y-axis normalized value (the broken line), and the centrifugal acceleration (the dash-dotted line) over time. Each of the X-axis normalized value and the Y-axis normalized value is related to the left vertical axis. The centrifugal acceleration is related to the right vertical axis. FIG. 23 is a graph when the nut 240A is rotated counterclockwise by 45 degrees from the state of FIG. 5.

In the present embodiment, since the vehicle 200 starts traveling at time t11, the centrifugal acceleration increases to about 15 G as illustrated in FIG. 23. After time t11, the X-axis normalized value is about −1 G, and the Y-axis normalized value is about 0 G. As illustrated in FIG. 23, the amount of change (amplitude) of the X-axis normalized value of about −1 G is smaller than the amount of change (amplitude) of the Y-axis normalized value of about 0 G.

Therefore, in the case where the fastening state of the nut 240 is detected by directly comparing the X-axis normalized value or the Y-axis normalized value with the predetermined allowable range instead of the rotation angle of the sensor device 500, the allowable range when the X-axis normalized value or the Y-axis normalized value is about 0 G is set to be larger than the allowable range when the X-axis normalized value or the Y-axis normalized value is about −1 G (or 1 G). Thus, even when the X-axis normalized value or the Y-axis normalized value is about 0 G, the fastening state of the nut 240 can be detected more accurately. This control may be applied to the second and third embodiments.

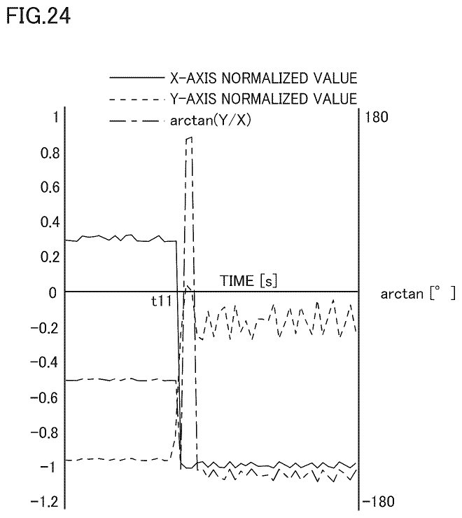

Further, the fastening state of the nut 240 may be detected based on the arctangent function values of the X-axis normalized value and the Y-axis normalized value. FIG. 24 illustrates the waveform of the inverse trigonometric function value instead of the waveform of the centrifugal acceleration of FIG. 20. In this case, the allowable range can be narrowed as compared with the case of FIG. 23. As described in the third embodiment, the arctangent function value can only be in the range of −90 degrees to 90 degrees, but the arctangent function value may be changed to the range of 0 degrees to 360 degrees by adding or subtracting 180 degrees or 360 degrees based on the sign of the X-axis acceleration and the sign of the Y-axis acceleration.

### Processing Flow of Sensor Device

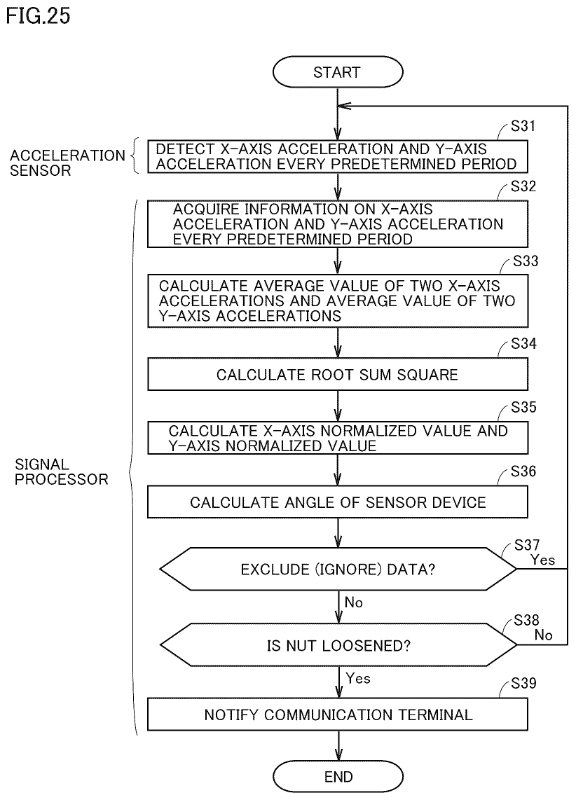

Next, a processing flow of the sensor device 500 will be described with reference to FIG. 25. Steps S31 to S33 are the same as steps S11 to S13 in the second embodiment.

In step S34, the signal processor 32 (the root sum square calculation unit 32a) calculates a root sum square of the X-axis acceleration (X-axis average acceleration) and the Y-axis acceleration (Y-axis average acceleration).

In step S35, the signal processor 32 (the normalization unit 32b) calculates an X-axis normalized value and a Y-axis normalized value based on the root sum square calculated in step S34.

In step S36, the signal processor 32 (the rotation angle calculation unit 32c) calculates an angle (rotation angle) of the sensor device 500 (nut 240) based on the X-axis normalized value and the Y-axis normalized value calculated in step S35.

In step S37, the signal processor 32 determines whether or not the data acquired in step S36 should be excluded (ignored) based on the angle (rotation angle) of the sensor device 500 acquired in step S36. When it is determined that the data should be excluded (ignored) (Yes in S37), the procedure returns to step S31. When it is determined that the data should not be excluded (ignored) (No in S37), the procedure proceeds to step S38. The data (measured value) to be excluded (ignored) is not limited to the X-axis normalized value and the Y-axis normalized value, and may be the X-axis acceleration and the Y-axis acceleration.

In step S37, similar to the third embodiment, when the information B indicating that the nut 240 has been rotated in the loosening direction by the rotation angle equal to the rotation angle in the tightening direction is acquired immediately after the information indicating that the nut 240 has been rotated in the tightening direction by the predetermined angle or more in a state where the nut 240 has not loosened for a predetermined time or more is acquired, it is determined that the data should be excluded (ignored). Further, in step S37, similar to the second embodiment, when the centrifugal acceleration of the wheel rim 220 is less than a predetermined value and the data is obtained when the centrifugal acceleration suddenly changes, it may be determined that the data should be excluded (ignored).

Next, in step S38, the signal processor 32 (the fastening state detection unit 32d) detects the fastening state of the nut 240 based on the angle (rotation angle) of the sensor device 500 (nut 240) calculated in step S36. If it is detected that the nut 240 is loosened (Yes in S38), the procedure proceeds to step S39. If it is detected that nut 240 is not loosened (No in S38), the procedure returns to step S31. In step S38, as described above, the signal processor 32 (the fastening state detection unit 32d) determines whether or not the nut 240 is loosened based on an amount of change (a difference) from a previous angle or an initial value of the sensor device 500. Step S39 is the same as step S16 of the second embodiment.

As described above, in the fourth embodiment, the rotation angle of the nut 240 is detected based on each of the X-axis normalized value and the Y-axis normalized value. Thus, the rotation angle of the nut 240 can be detected without considering the change in the vehicle speed (centrifugal force).

### Fifth Embodiment

Next, a fifth embodiment will be described. In the fifth embodiment, the fastening state of the nut 240 is detected based on the positive or negative sign of the X-axis acceleration and the Y-axis acceleration. In the fifth embodiment, the same components as those in the first to fourth embodiments are denoted by the same reference numerals as those in the first to fourth embodiments, and the description thereof will not be repeated.

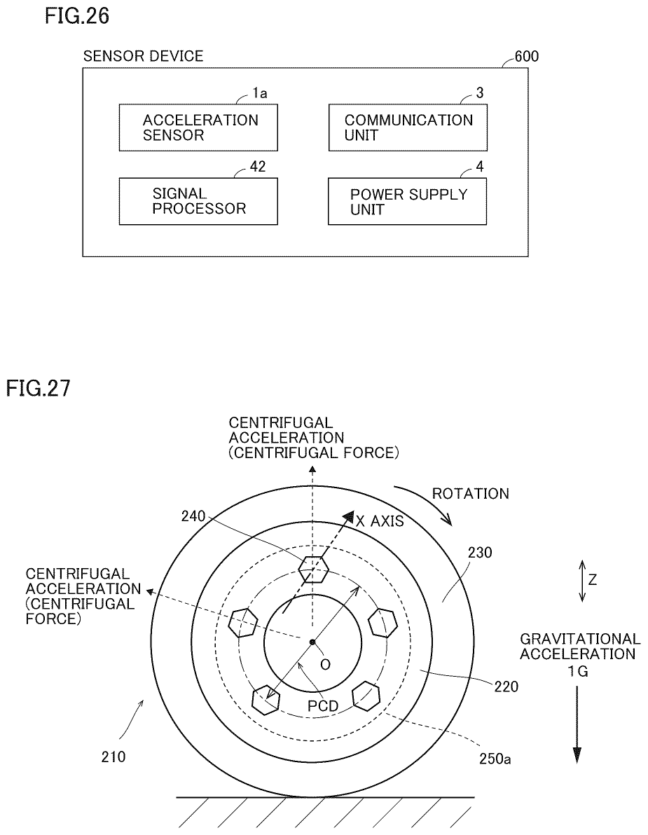

As illustrated in FIG. 26, the sensor device 600 includes an acceleration sensor 1a, a signal processor 42, a communication unit 3, and a power supply unit 4. The signal processor 42 is an example of a “state detection unit” and a “state detection device” in the present disclosure.

FIG. 27 is a side view illustrating a state in which the wheel rim 220 (the wheel 210) is fastened to the wheel hub 250a. In FIG. 27, the sensor device 600 is provided in the nut 240 located at the uppermost position. The detection axis of the acceleration sensor la is defined as the X axis. The acceleration sensor la detects an acceleration applied to the detection axis (X axis). The acceleration detected on the detection axis (X axis) is denoted by Gx. The arrow of the X axis indicates the positive direction of Gx. When the acceleration applied to the acceleration sensor 1a has a component (vector) in the arrow direction of the X axis (the arrow direction of the two-dot chain line), Gx has a positive value (+Gx, i.e., a positive acceleration). When the acceleration applied to the acceleration sensor 1a has a component in the opposite direction to the arrow direction of the X axis, Gx has a negative value (−Gx, i.e., a negative acceleration).

The wheel rim 220 (the wheel 210) is fastened to the wheel hub 250a by the nuts 240 on a predetermined pitch circle (see the dash-dotted line in FIG. 27). The pitch circle diameter (PCD) is arbitrary, and may be, for example, 114.3 mm or 275 mm. FIG. 27 illustrates a state in which the nuts 240 are tightened with a predetermined tightening torque to fasten the wheel rim 220 (the wheel 210) to the wheel hub 250a. Each nut 240 has a right-hand thread, and is fastened when being screwed clockwise in FIG. 27.

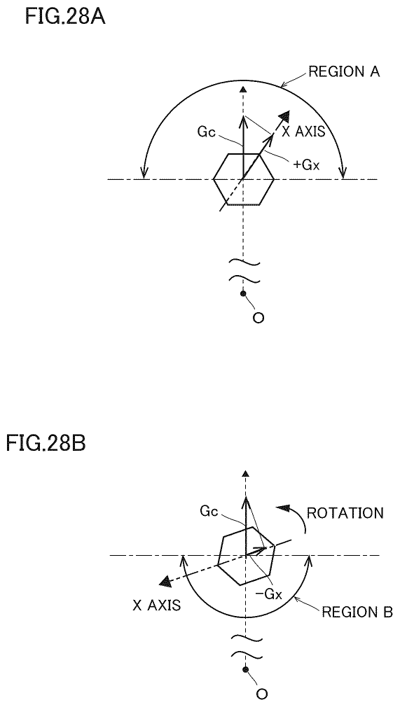

FIGS. 28A and 28B are diagrams illustrating the relationship between a centrifugal acceleration and an acceleration Gx detected by the acceleration sensor 1a. FIG. 28A illustrates a state in which the nut 240 is tightened with a predetermined tightening torque (the state illustrated in FIG. 27). FIG. 28B illustrates a state in which the nut 240 is rotated in the loosening direction (counterclockwise). Although the gravitational acceleration is applied to the nut 240 (the acceleration sensor 1a) as illustrated in FIG. 27, in the description with reference to FIGS. 28A and 28B, the gravitational acceleration is ignored. In other words, the relationship between the centrifugal acceleration and the acceleration Gx detected by the acceleration sensor 1a will be described on the assumption that the rotation axis O of the wheel hub 250a (the wheel rim 220) is oriented in the vertical direction and the wheel rim 220 rotates on a horizontal plane. In this case, the gravitational acceleration is not applied to the acceleration sensor 1a in the detection axis (X axis) direction.

In FIGS. 28A and 28B, the dashed arrow indicates the direction of the centrifugal acceleration (centrifugal force) generated by the rotation of the wheel hub 250a (the wheel rim 220). Since the centrifugal acceleration acts in the radial direction around the rotation axis O, the nut 240 (the acceleration sensor 1a) acts in the direction illustrated in FIGS. 28A and 28B at any position on the pitch circle. In FIGS. 28A and 28B, an arrow Gc indicates a vector of the centrifugal acceleration, and a vector Gc is always oriented in the radial direction around the rotation axis O.

In FIG. 28A which illustrates a state in which the nut 240 is tightened with a predetermined tightening torque, the X-axis direction component (a component in the detection axis direction of the acceleration sensor 1a) of the vector Gc (centrifugal acceleration) is detected by the acceleration sensor 1a as “+Gx (positive acceleration)”. When the nut 240 is rotated in the loosening direction (counterclockwise direction), the fastening state of the nut 240 is loosened to the state illustrated in FIG. 28B, the X-axis direction component (a component in the detection axis direction of the acceleration sensor 1a) of the vector Gc (centrifugal acceleration) is detected by the acceleration sensor 1a as “−Gx (negative acceleration)”.

As viewed from FIGS. 28A and 28B, when the detection axis (the X-axis) of the acceleration sensor 1a rotates across an axis orthogonal to the vector Gc of the centrifugal acceleration (the axis indicated by the dash-dotted line in FIGS. 28A and 28B), the direction of the acceleration detected by the acceleration sensor 1a changes, in other words, the acceleration Gx detected by the acceleration sensor 1a changes from the positive acceleration (+Gx) to the negative acceleration (−Gx) or changes from the negative acceleration (−Gx) to the positive acceleration (+Gx). In other words, the positive or negative sign of the acceleration detected by the acceleration sensor 1a is reversed. In a case where a centrifugal acceleration is applied to the acceleration sensor 1a, when the detection axis (the X axis) of the acceleration sensor 1a rotates and the direction (the arrow of the X axis) in which the positive direction of Gx is detected changes from a region A illustrated in FIG. 28A to a region B illustrated in FIG. 28B, the acceleration Gx changes from +Gx to −Gx. As a result, the positive or negative sign of the acceleration detected by the acceleration sensor 1a is reversed. In a state where a centrifugal acceleration is applied to the acceleration sensor 1a, when the detection axis (the X axis) of the acceleration sensor 1a rotates and the direction (the arrow of the X axis) in which the positive direction of Gx is detected changes from the region B illustrated in FIG. 28B to the region A illustrated in FIG. 28A, the acceleration Gx changes from −Gx to +Gx. As a result, the positive or negative sign of the acceleration detected by the acceleration sensor 1a is reversed.

The acceleration sensor 1a rotates in conjunction with the rotation of the nut 240. Therefore, when a centrifugal acceleration caused by the rotation of the wheel rim 220 is applied, the rotation of the nut 240 can be detected based on the fact that the positive or negative sign of the acceleration Gx detected by the acceleration sensor 1a is reversed. In the fifth embodiment, a change in the fastening state of the nut 240 can be detected based on this fact.

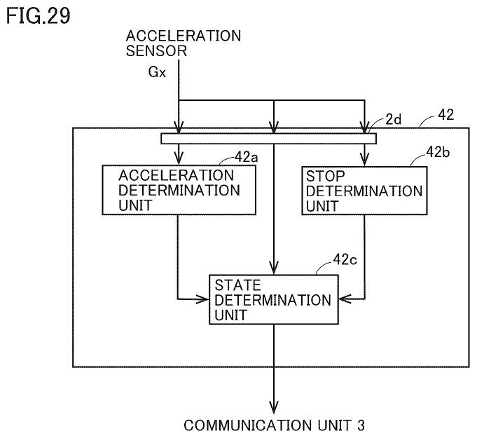

FIG. 29 is a diagram illustrating an example of functional blocks configured in the signal processor 42. The acceleration determination unit 42a determines whether or not the gravitational acceleration applied to the acceleration sensor 1a is greater than the centrifugal acceleration. As illustrated in FIG. 27, the rotation axis O of the wheel rim 220 (the rotation axis O of the wheel hub 250a) is a horizontal axis, and the gravitational acceleration is applied to the acceleration sensor 1a in addition to the centrifugal acceleration. The acceleration Gx detected by the acceleration sensor 1a is a composite acceleration of the centrifugal acceleration and the gravitational acceleration. Therefore, when the gravitational acceleration applied to the detection axis of the acceleration sensor 1a is larger than the centrifugal acceleration applied to the detection axis, the direction (the positive or negative sign) of the acceleration Gx may change depending on the position of the nut 240 on the pitch circle even if the nut 240 does not rotate.

When the magnitude of the gravitational acceleration is 1 G, the maximum magnitude of the gravitational acceleration (the gravitational acceleration acting in the X-axis direction) detected by the acceleration sensor 1a is 1 G. When the absolute value of the acceleration Gx detected by the acceleration sensor 1a is larger than 2 G, a centrifugal acceleration larger than the gravitational acceleration is applied to the acceleration sensor 1a. Therefore, when the absolute value of the acceleration Gx detected by the acceleration sensor 1a is larger than 2 G, the rotation of the nut 240 can be detected based on the acceleration Gx without considering the effect of the gravitational acceleration. In other words, when the absolute value of the acceleration Gx detected by the acceleration sensor 1a is smaller than 2 G, the effect of the gravitational acceleration should be considered.

In the fifth embodiment, the acceleration determination unit 42a determines that the centrifugal acceleration is greater than the gravitational acceleration if the absolute value of the acceleration Gx detected by the acceleration sensor 1a is 5 G or more, and determines that the gravitational acceleration is greater than the centrifugal acceleration if the absolute value of the acceleration Gx is less than 5 G.

The stop determination unit 42b determines whether or not the vehicle 200 is stopped and the rotation of the wheel hub 250a (the wheel rim 220) is stopped.

The stop determination unit 42b determines that the rotation of the wheel hub 250a (the wheel rim 220) is stopped when the magnitude of the previous value of the acceleration Gx (X-axis average acceleration) detected by the acceleration sensor 1aevery predetermined period is the same as the magnitude of the current value. In the fifth embodiment, if the magnitude of the previous value of the acceleration Gx is denoted by Gx(n−1) and the magnitude of the current value of the acceleration Gx is denoted by Gx(n), it is determined that the wheel rim 220 is stopped when the relationship |Gx(n−1)−Gx(n)|<α continues for a certain period of time, for example, when the relationship holds for three times in succession. It should be noted that a is a predetermined value that takes into consideration the effect of noise and disturbance when the acceleration Gx is detected, and is set in advance through experiments or the like.

When the positive or negative sign of the acceleration Gx (the X-axis average acceleration) detected by the acceleration sensor 1a is reversed (changed), the state determination unit 42c determines that the fastening state of the nut 240 is loose. The expression that the positive or negative sign of the acceleration Gx is reversed refers to a case where the acceleration Gx changes from a positive acceleration (+Gx) to a negative acceleration (−Gx) or from a negative acceleration (−Gx) to a positive acceleration (+Gx). The state determination unit 42c is an example of a “fastening state detection unit” in the present disclosure.

In the fifth embodiment, when the sign of the previous value of the acceleration Gx (the X-axis average acceleration) detected by the acceleration sensor 1a is different from the sign of the current value of the acceleration Gx (the X-axis average acceleration) detected by the acceleration sensor 1a, the state determination unit 42c determines that the positive or negative sign of the acceleration Gx is reversed, and determines that the fastening state of the nut 240 has changed. The state determination unit 42c according to the fifth embodiment cannot detect the rotation direction of the nut 240. When the wheel hub 250a (the wheel rim 220) is rotating, it is extremely rare that the nut 240 is rotated in the tightening direction (retightening direction). Therefore, when the direction (the positive or negative sign) of the acceleration Gx detected by the acceleration sensor la which rotates in conjunction with the rotation of the nut 240 changes, it could be estimated that the nut 240 is rotated in the loosening direction.

After determining that the fastening state of the nut 240 has changed, the state determination unit 42c transmits the information to the communication terminal 201 (see FIG. 1) of the vehicle 200 via the communication unit 3. Upon receiving the transmitted information, the communication terminal 201 alerts (displays), for example, the looseness of the nut 240.

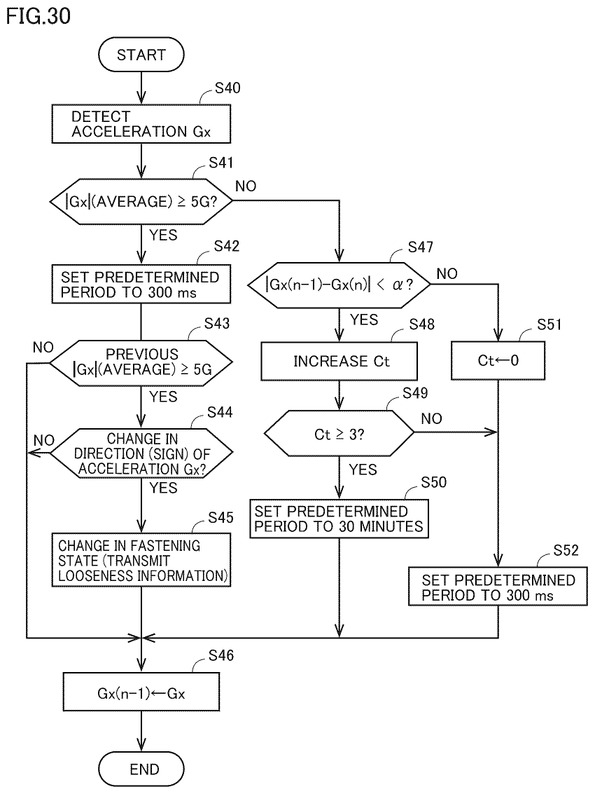

FIG. 30 is a flowchart illustrating an example process executed by the signal processor 42. This flowchart is repeatedly performed every predetermined period. The predetermined period is initially set to 300 ms, for example.

In step S40, the signal processor 42 acquires the acceleration Gx detected by the acceleration sensor 1a. The signal processor 42 acquires information on the acceleration Gx detected by the acceleration sensor 1a every predetermined period (for example, 150 ms). Upon receiving an acceleration detection request from the signal processor 42, the acceleration sensor 1a detects the acceleration detection Gx and transmits the detection signal to the signal processor 42. Therefore, the signal processor 42 acquires the information on the acceleration Gx from the acceleration sensor 1a every predetermined period.

In step S41, the signal processor 42 determines whether or not an absolute value |Gx| of the acceleration Gx (detected by the acceleration sensor 1a) acquired in step S40 is 5 G or more. Specifically, whether or not the absolute value |Gx| (average) of an average value (X-axis average acceleration) of two accelerations Gx acquired in step S40 is 5 G or more is determined. When it is determined that the absolute value |Gx| (average) is 5 G or more, i.e., a positive determination is made, the procedure proceeds to S42. When it is determined that the absolute value |Gx| (average) is less than 5 G, i.e., a negative determination is made, the procedure proceeds to step S47.

In step S42, the signal processor 42 sets the processing interval (the predetermined period) to, for example, 300 ms. Then, the procedure proceeds to step S43. The processing interval (predetermined period) is, for example, twice the period (150 ms in the above) in which the acceleration sensor 1a detects the acceleration Gx. If the predetermined period is already set to 300 ms in step S42, the predetermined period is maintained at 300 ms.

In step S43, the signal processor 42 determines whether or not the absolute value |Gx| (average) of the acceleration Gx (the previous value Gx(n−1)) acquired in step S40 in the previous time is 5 G or more. If the absolute value |Gx| (average) of the previous acceleration Gx (the previous value Gx(n−1)) is 5 G or more, i.e., an affirmative determination is made, the procedure proceeds to step S44. If the absolute value |Gx| (average) of the previous acceleration Gx (the previous value Gx(n−1)) is less than 5 G, i.e., a negative determination is made, the procedure proceeds to step S46.

In step S44, the signal processor 42 determines whether or not the direction of the acceleration Gx (the X-axis average acceleration) has changed. The signal processor 42 determines whether or not the direction of the acceleration Gx detected in the current time by the acceleration sensor 1a in step S40 and the direction of the acceleration Gx (the previous value Gx(n−1)) detected in the previous time have changed. When the sign of the acceleration Gx detected in the current time by the acceleration sensor 1a is different from the sign of the acceleration Gx (the previous value Gx(n−1)) detected in the previous time, the signal processor 42 determines that the direction of the acceleration Gx has changed and the sign of the acceleration Gx has been reversed.

If it is determined in step S44 that the direction of the acceleration Gx (the X-axis average acceleration) has changed (affirmative determination), the procedure proceeds to step S45. If it is determined in step S44 that the direction of the acceleration Gx (the X-axis average acceleration) has not changed (negative determination), the procedure proceeds to step S46.

In step S45, the signal processor 42 determines that the fastening state of the nut 240 has changed, and transmits looseness information of the nut 240 to the communication terminal 201 via the communication unit 3.

In step S46, the signal processor 42 stores the acceleration Gx (the X-axis average acceleration) acquired in step S40 in the memory as the previous value Gx(n−1) of the acceleration Gx, and then ends the current routine.

In step S47, the signal processor 42 determines whether or not the difference between the magnitude (the previous value Gx(n−1)) of the acceleration Gx acquired in the previous time and the magnitude (the current value Gx(n)) of the acceleration Gx acquired in step S40 in the current time is smaller than a predetermined value α. If |Gx(n−1)−Gx(n)|<α is satisfied, i.e., an affirmative determination is made, the procedure proceeds to step S48. If |Gx(n−1)−Gx(n)|≥α is satisfied, i.e., a negative determination is made, the procedure proceeds to step S51.

In step S48, the signal processor 42 increases a counter Ct, and then proceeds to step S49. In step S49, the signal processor 42 determines whether or not the counter Ct is 3 or more. In step S49, if the counter Ct is 3 or more (Ct≥3), i.e., an affirmative determination is made, the procedure proceeds to step S50, and if the counter Ct is less than 3 (Ct<3), i.e., a negative determination is made, the procedure proceeds to step S52.

In step S50, the signal processor 42 sets the processing interval (the predetermined period) of this flowchart to 30 minutes, and then ends the current routine after step S46. In step S51, the counter Ct is set to 0.

In step S52, the signal processor 42 sets the processing interval (the predetermined period) of this flowchart to 300 ms, and then ends the current routine after step S46.

According to the fifth embodiment, the acceleration sensor la rotates in conjunction with the rotation of the nut 240, and rotates integrally with the rotation of the nut 240 in the tightening direction and the loosening direction. The acceleration sensor la detects an acceleration Gx toward one direction of the detection axis (the X axis) orthogonal to the rotation axis O of the wheel hub 250a (the vehicle axis) as a positive acceleration (+Gx), and detects an acceleration Gx toward the other direction of the detection axis (the X axis) as a negative acceleration (−Gx). When the detection axis (the X axis) of the acceleration sensor la rotates across the axis orthogonal to the vector Gc of the centrifugal acceleration, the direction of the acceleration detected by the acceleration sensor 1a changes, and the acceleration Gx detected by the acceleration sensor 1a changes from the positive acceleration (+Gx) to the negative acceleration ( −Gx) or from the negative acceleration (−Gx) to the positive acceleration (+Gx), and thereby the positive or negative sign of the acceleration Gx is reversed. The state determination unit 42c of the signal processor 42 determines that the fastening state of the nut 240 has changed when the acceleration Gx detected by the acceleration sensor 1a is reversed.

The state determination unit 42c cannot detect the rotation direction of the nut 240. However, when the wheel hub 250a (the wheel rim 220) is rotating, it is extremely rare that the nut 240 is rotated in the tightening direction (retightening direction). Therefore, when the direction (the positive or negative sign) of the acceleration Gx detected by the acceleration sensor la rotating integrally with the nut 240 changes, it can be estimated that the nut 240 is rotated in the loosening direction. Therefore, in the fifth embodiment, when the nut 240 is rotated in the loosening direction, it can be estimated that the fastened state of the nut 240 is loosened, and therefore, the loosening of the nut 240 can be detected even when the loosening is relatively small.

In the fifth embodiment, the change in the fastening state of the nut 240 (the rotation of the nut 240) is detected based on the direction (the positive or negative sign) of the acceleration Gx detected by the acceleration sensor 1a. Therefore, the acceleration sensor 1a only needs to be capable of detecting the direction (positive or negative) of the acceleration Gx, and may be a low-G acceleration sensor having a relatively small acceleration detection range. For example, in the fifth embodiment, an acceleration sensor capable of detecting an acceleration of at least 5 G may be used.

In the fifth embodiment, when the absolute value |Gx| of the acceleration Gx detected by the acceleration sensor 1a is larger than 5 G, a centrifugal acceleration larger than the gravitational acceleration is applied to the acceleration sensor 1a (S41). However, it is acceptable that when the absolute value |Gx| is larger than a predetermined value larger than 2 G, a centrifugal acceleration larger than the gravitational acceleration is applied to the acceleration sensor 1a. In addition, in a case where the rotation speed of the wheel hub 250a (the wheel rim 220) can be calculated from the vehicle speed or the like of the vehicle 200, a change in the direction (positive or negative) of the acceleration Gx may be detected when the centrifugal acceleration calculated based on the rotation speed of the wheel hub 250a (the wheel rim 220) and the PCD is larger than the gravitational acceleration.

In the fifth embodiment, the stop determination unit 42b determines the stop of the rotation of the wheel hub 250a (the wheel rim 220) based on the acceleration Gx detected by the acceleration sensor 1a. However, the vehicle speed information on the vehicle 200 may be acquired via the communication unit 3, and when the vehicle 200 is stopped, the stop of the rotation of the wheel hub 250a (the wheel rim 220) may be determined.

### First Modification

In the fifth embodiment, whether or not the positive or negative sign of the acceleration Gx is reversed is detected based on the sign of the previous value and the sign of the current value of the acceleration Gx detected by the acceleration sensor 1a. In the first modification, an initial value Gxs is set for the acceleration Gx (the X-axis average acceleration), and whether or not the positive or negative sign of the acceleration Gx is reversed is detected based on the sign of the initial value Gxs and the sign of the acceleration Gx (the X-axis average acceleration) detected by the acceleration sensor 1a.

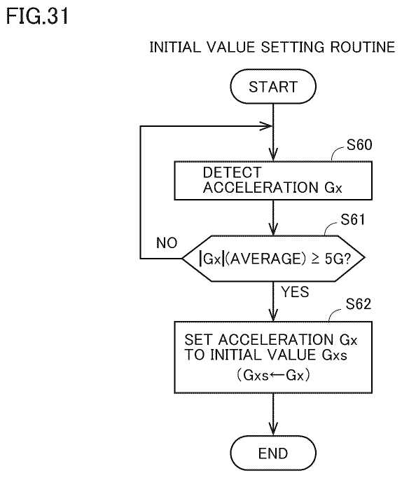

FIG. 31 is a flowchart illustrating an initial value setting routine executed by the signal processor 42 according to the first modification. When a button 201a (see FIG. 1) provided on the communication terminal 201 of the vehicle 200 is pressed, the signal processor 42 receives the pressing of the button 201a via the communication unit 3, and starts the process.

When the button 201a is pressed, the acceleration Gx is detected by the acceleration sensor la in step S60. In the following step S61, it is determined whether or not the absolute value |Gx| (average) of the acceleration Gx is 5 G or more. When the absolute value |Gx| is less than 5 G, i.e., a negative determination is made, the procedure returns to step S60, and the acceleration Gx is detected again by the acceleration sensor 1a.

When the vehicle 200 starts traveling and the absolute value |Gx| (average) of the acceleration Gx detected by the acceleration sensor 1a becomes greater than 5 G, i.e., an affirmative determination is made in step S61, the procedure proceeds to step S62. In step S62, the acceleration Gx detected by the acceleration sensor 1a is set to the initial value Gxs, and the current routine ends. The initial value Gxs includes the direction (sign (+/−)) of the acceleration Gx detected by the acceleration sensor 1a.

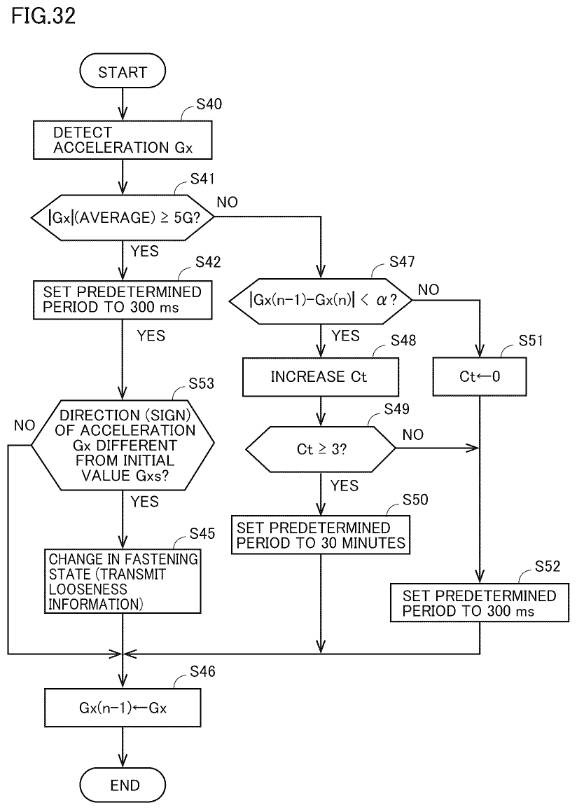

FIG. 32 is a flowchart illustrating an example process executed by the signal processor 42 according to the first modification. Similar to the flowchart of FIG. 30, this flowchart is repeatedly executed every predetermined period, and the predetermined period is set to 300 ms in advance. This flowchart omits step S43 of the flowchart of FIG. 30 and replaces step S43 with step S53. Therefore, the description of steps S40 to S42 and S44 to S52 will not be repeated.

In step S53, the signal processor 42 determines whether or not the direction of the acceleration Gx (the X-axis average acceleration) detected in step S40 is different from the direction of the initial value Gxs. If the sign of the acceleration Gx is different from the sign of the initial value Gxs (YES in S53), it is determined that the sign of the acceleration Gx is inverted, and the procedure proceeds to step S45. If the sign of the acceleration Gx is the same as the sign of the initial value Gxs, i.e., a negative determination is made, the procedure proceeds to step S46.

According to the first modification, since the initial value Gxs is the acceleration Gx indicating the rotational position of the nut 240 after the completion of tightening, it is possible to detect a change in the fastening state from when the nut 240 is tightened at a predetermined tightening torque. As a result, the fastening state of the nut 240 can be detected more appropriately.

When the vehicle 200 (the communication terminal 201) is not provided with a button 201a, the initial value setting routine of FIG. 31 may be executed when the vehicle 200 returns from the stopped state to the traveling state. For example, when an affirmative determination is made in step S47 or when an affirmative determination is made in step S41 or a negative determination is made in step S47, the initial value setting routine of FIG. 31 may be executed. When it is determined from the vehicle speed information on the vehicle 200 that the vehicle 200 has returned from the stopped state to the traveling state, the initial value setting routine of FIG. 31 may be executed. The button 201a may be provided on the nut 240.

### Second Modification

In the fifth embodiment, the detection axis of the acceleration sensor la is one axis (the X axis). When the detection axis of the acceleration sensor la is one axis (the X axis), the direction (the positive or negative sign) of the acceleration Gx may not change unless the nut 240 (the acceleration sensor 1) is rotated by 180° or more. Further, depending on the rotational position of the nut 240 at the completion of tightening, the positive or negative sign of the acceleration Gx may be reversed only by a slight rotation. Therefore, in the second modification, the X-axis acceleration and the Y-axis acceleration may be detected by the acceleration sensor 1 as in the first to fourth embodiments.

In the second modification, the signal processor 42 executes the process of the flowchart in FIG. 30 based on the X-axis acceleration Gx detected by the acceleration sensor 1. The signal processor 42 executes the process of the flowchart in FIG. 30 based on the Y-axis acceleration Gy detected by the acceleration sensor 1. Note that Gx is replaced with Gy.

According to the second modification, when the nut 240 is rotated by at least 90°, the positive or negative sign of one of the acceleration Gx and the acceleration Gy is reversed, and thereby it is possible to detect a change in the fastening state of the nut 240.

According to the second modification, if it is determined that the fastening state of the nut 240 has changed when the positive or negative sign of one of the acceleration Gx and the acceleration Gy is reversed and then the positive or negative sign of the other one of the acceleration Gx and the acceleration Gy is reversed, it is possible to detect the change in the fastening state of the nut 240 when the nut 240 is rotated by 90° or more. Although the acceleration sensor 1 according to the second modification and the first to fourth embodiments includes two axes of the X axis (first detection axis) and the Y axis (second detection axis) orthogonal to each other as the detection axes, the two axes of the X axis (first detection axis) and the Y axis (second detection axis) may not be orthogonal to each other. In addition, the detection axis of the acceleration sensor may be three or more axes intersecting at an arbitrary angle as long as the plane is orthogonal to the rotation axis of the wheel rim 220 (the rotation axis O of the wheel hub 250a). In this case, it is preferable that the plurality of detection axes of the acceleration sensor intersect with each other at equal angles (for example, 120° in the case of three axes).

### Third Modification

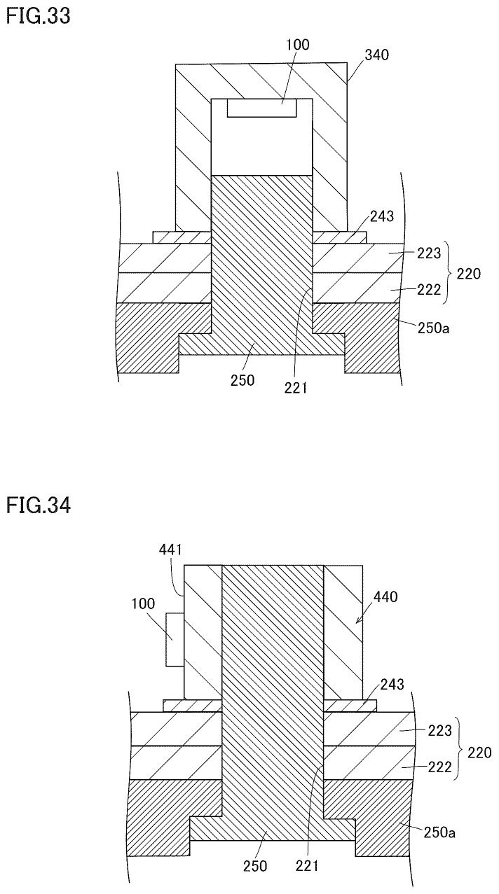

Although the nut cap 241 is attached to the nut 240 in the first to fifth embodiments described above, the present disclosure is not limited thereto. As illustrated in FIG. 33, the sensor device may be attached to a nut 340 that is a cap nut. The nut 340 is an example of a “fastening member” in the present disclosure. In FIG. 33, the sensor device 100 is illustrated as a representative example of a sensor device.

### Fourth Modification

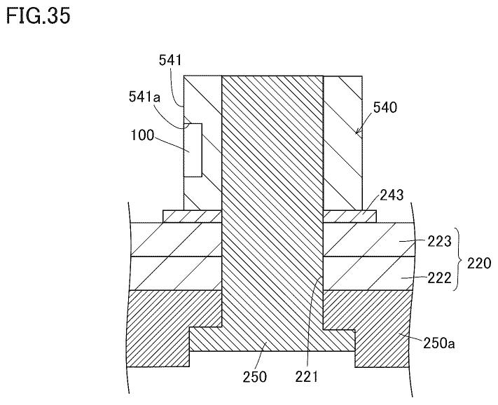

In a fourth modification illustrated in FIG. 34, a nut 440 is open on one side and does not include a nut cap. In the fourth modification, the sensor device may be provided on a side surface 441 of the nut 440 (a surface that is orthogonal to the wheel rim 220). In FIG. 34, the sensor device 100 is illustrated as a representative example of the sensor device. Each of the components in the fourth modification may be applied to the second to fifth embodiments. The sensor device may be fitted into a recess 541a (see FIG. 35) provided on a side surface 541 of a nut 540. Each of the nut 440 and the nut 540 is an example of a “fastening member” in the present disclosure.

### Comparative Example

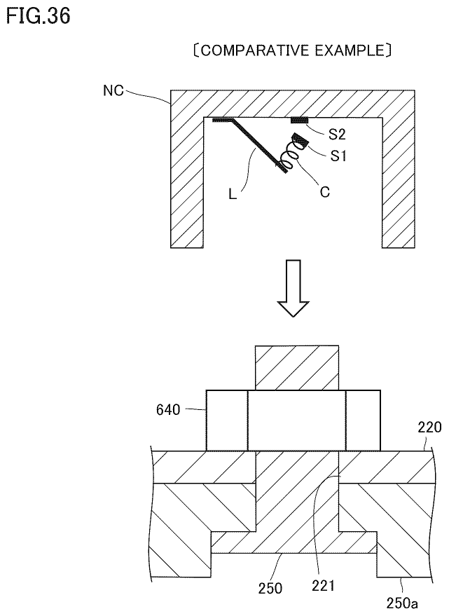

FIG. 36 is a cross-sectional view of a fastening member equipped with a looseness detection device according to a comparative example. In FIG. 36, each of the wheel hub 250a and the bolt 250 is the same as that in the embodiments described above. In FIG. 36, a single tire is fastened to a wheel hub 250a. The wheel rim 220 is one. Also, in FIG. 35, a nut 640, which is a through nut, is illustrated in a side view (not a cross-sectional view).

In the comparative example, a plate spring L, a coil spring C, a contact S1, and a contact S2 are provided in an inner space of a nut cap NC. One end of the plate spring L is fixed to the ceiling surface of the nut cap NC. The other end of the plate spring L is attached to one end of the coil spring C. The other end of the coil spring C is fixed to the contact point S1. The contact S2 is provided on the ceiling surface of the nut cap NC facing the contact S1. The nut cap NC is attached to the nut 640 as indicated by an arrow. For example, the nut cap NC is attached to the nut 640 by pressing the inner surface of the nut cap NC onto the side surface of the nut 640.

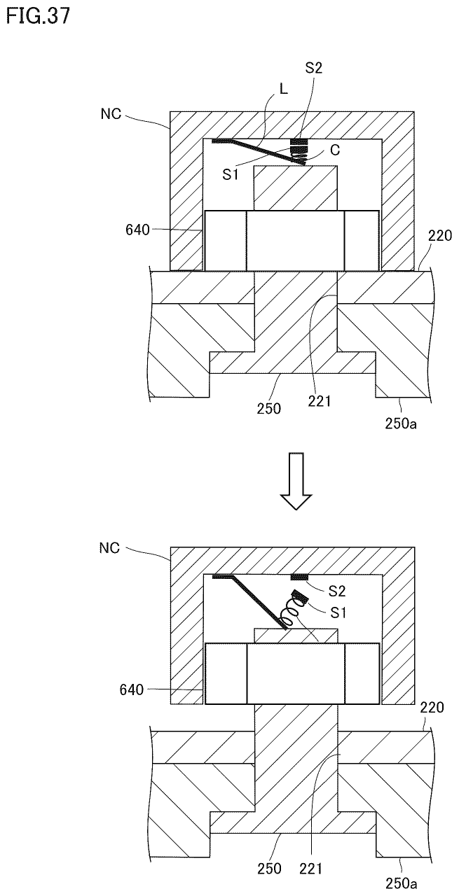

FIG. 37 is a diagram illustrating a state in which the nut cap NC is attached to the nut 640 (the upper view) and a state in which the nut 640 is loosened (the lower view) according to the comparative example. The upper view illustrates a state in which the nut 640 is fastened with a predetermined tightening torque. When the nut 640 is fastened with a predetermined tightening torque, the distance between the ceiling surface of the nut cap NC attached to the nut 640 and the upper surface (the tip end) of the bolt 250 is short. In this case, as illustrated in the upper view, the plate spring L and the coil spring C are compressed, the contact point S1 and the contact point S2 are brought into contact with each other, and thereby the contact point S1 and the contact point S2 are closed.

As illustrated in the lower view, when the fastening state of the nut 640 is loosened, a gap is formed between the nut 640 and the fastening surface of the wheel rim 220. When this gap is formed, the distance between the ceiling surface of the nut cap NC attached to the nut 640 and the upper surface of the bolt 250 becomes longer. In this case, the contact point S1 and the contact point S2 are separated from each other, and thereby the contact point S1 and the contact point S2 are opened.

In the looseness detection device of the comparative example, the looseness of the nut 640 may be detected by electrically detecting the opening state and closing state of the contact point S1 and the contact point S2. For example, when the contact point S1 and the contact point S2 are closed, it may be determined that the fastening state of the nut 640 is normal, and when the contact point S1 and the contact point S2 are opened, it may be determined that the nut 640 is loose.

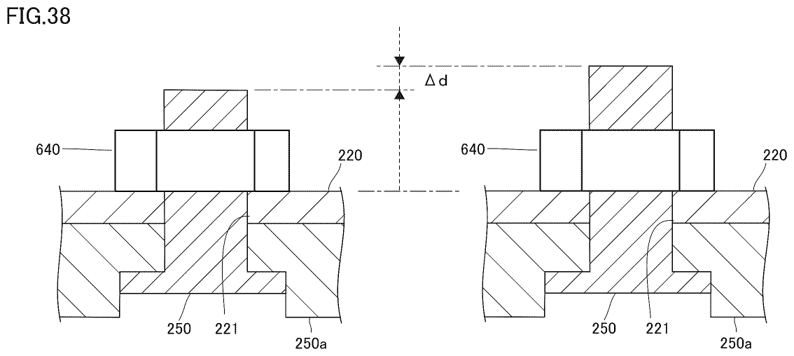

FIG. 38 is a diagram illustrating a difference in the shaft length of the bolt 250. The shaft length of the bolt 250 varies depending on the vehicle model and the car manufacturer (vehicle manufacturer). The left diagram of FIG. 38 illustrates an example bolt 250 which has a shorter shaft length. The right diagram of FIG. 38 illustrates an example bolt 250 which has a longer shaft length. As illustrated in FIG. 38, due to the different shaft lengths of the bolts 250, a difference (Δd) occurs in the distance from the fastening surface between the wheel rim 220 and the nut 640 to the upper surface of the bolt 250. Therefore, the looseness detection device disposed on the nut cap NC according to the comparative example may not properly detect the looseness of the nut 640.

In contrast, in the detection device according to the above embodiment, since the fastening state of the fastening member is detected based on the acceleration detected by the acceleration sensor 1 (1a), the fastening state can be detected without being affected by the difference in the shaft length of the bolt 250.

In the description of the first embodiment, the acceleration sensor 1 detects the acceleration of each of the X axis and the Y axis and calculates the acceleration of each of the X axis and the Y axis and the difference between the X-axis acceleration and the Y-axis acceleration, but the present disclosure is not limited thereto. For example, in the example of FIG. 12, only the acceleration of the X axis and the acceleration of the Y axis are used. Alternatively, the acceleration sensor may be configured to detect only one of the X-axis acceleration and the Y-axis acceleration. Although it is described that an interval at which the sensing is repeatedly performed is appropriately set to reduce power consumption of the signal processor 2, the present disclosure is not limited thereto. Even if the interval is arbitrary, a variation will occur.

As described above, a variation will occur when the sensing interval is arbitrary. Taking the X axis as an example, a variation with an average value of about ±1 G will occur. The effect of this variation is illustrated in the example of FIG. 9A. If there is no variation and the average acceleration is 3 G, the sensor angle is 0 degrees. However, if the variation is −1 G, the average acceleration may be 2 G. When the average acceleration is 2 G, the sensor angle is about 40 degrees. Thus, the difference between 0 degrees and 40 degrees is the sensor angle error. In other words, unless the looseness of the sensor angle exceeds 40 degrees to some extent, it would be difficult to reliably determine the looseness of the nut. This reduces the robustness of the system.

When the acceleration sensor 1 detects only one of the X-axis and the Y-axis, the rotation angle cannot be determined because two rotation angle candidates of the nut 240 are detected, but the amount of change in the rotation angle between the two detections can be determined. Thus, if the amount of change is minute, it is possible to detect that the nut 240 is not loosened.

Specifically, the rotation angle of the nut 240 is detected to be around 90 degrees or around 270 degrees because the X-axis acceleration is 0 G (or because the Y-axis acceleration is 3 G), and the rotation angle is detected to be around 90 degrees or around 270 degrees in the next detection. In this case, since it is determined that the amount of change in the rotation angle is 0 (minute), it is detected that the nut 240 is not loosened. The looseness of the nut 240 may be detected based on the difference between the rotation angles detected in a plurality of consecutive detections.

### Fifth Modification

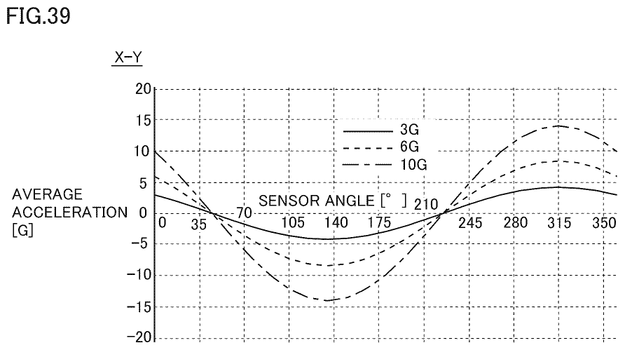

As a modification of the first embodiment, the looseness of the nut 240 may be detected based on a difference between the X-axis acceleration and the Y-axis acceleration. FIG. 39 is a graph illustrating an average difference between the X-axis acceleration and the Y-axis acceleration when the centrifugal force is 3 G, 6 G, and 10 G, respectively. For example, if the centrifugal force is 10 G and the difference is 0 G based on the speed of the vehicle 200, the rotation angle of the nut 240 is detected to be around 50 degrees or around 225 degrees. If the centrifugal force is 10 G and the difference is −10 G, the rotation angle of the nut 240 is detected to be around 90 degrees or around 175 degrees.

Further, in the first to fifth embodiments, it is described that the fastening state of the nut 240 provided on the wheel rim 220 of the vehicle 200 is detected, but the present disclosure is not limited thereto. For example, the fastening state of a fastening member such as a nut attached to an elevator pulley, a belt conveyor pulley, a coffee cup and a merry-go-round provided in an amusement park, or a rotating toy provided in a park may be detected. In the examples mentioned above, in the case of the rotating body rotating along a plane perpendicular to the gravitational direction, since the centrifugal force is not affected by the gravitational force, it is possible to easily detect the fastening state of the fastening member even when the centrifugal acceleration is small.

Further, in the first embodiment, it is described that the fastening state (the looseness) of the nut 240 is detected based on a change in the rotation angle of the nut 240, but the present disclosure is not limited thereto. The fastening state (the looseness) of the nut 240 may be detected by comparing an amount of change in the X-axis acceleration (X-axis average acceleration) and the Y-axis acceleration (Y-axis average acceleration) with a predetermined threshold value.

In addition, in the above-described embodiment, it is described that when the information A indicating that the nut 240 has been rotated by a predetermined angle or more in the tightening direction is acquired, the fastening state of the nut 240 is detected by ignoring the information A, but the present disclosure is not limited thereto. Even when the information indicating that the nut 240 has been rotated in the tightening direction by less than the predetermined angle is acquired, the fastening state of the nut 240 may be detected by ignoring the information.

In addition, in the embodiments described above, it is described that when the information A is acquired in a state in which the nut 240 is not loosened for a certain period of time or more, the fastening state of the nut 240 is detected by ignoring the information A, but the present disclosure is not limited thereto. Even when the information A is acquired in a state in which loosening of the nut 240 is detected within a predetermined time, the fastening state of the nut 240 may be detected by ignoring the information A.

In addition, in the embodiments described above, it is described that when the information B indicating that the nut 240 is rotated in the loosening direction by the rotation angle equal to the rotation angle in the tightening direction is acquired immediately after the information A is acquired, the fastening state of the nut 240 is detected by ignoring the information A, but the present disclosure is not limited thereto. When the information indicating that the nut 240 is rotated in the loosening direction by a rotation angle different from the rotation angle in the tightening direction is acquired immediately after the information A is acquired, the fastening state of the nut 240 may be detected by ignoring the information.

Further, in the embodiments described above, it is described that the fastening state of the nut 240 is detected when the centrifugal acceleration of the wheel rim 220 is equal to or greater than a predetermined value, but the present disclosure is not limited thereto. The fastening state of the nut 240 may be detected even when the centrifugal acceleration of the wheel rim 220 is less than the predetermined value.

In addition, in the embodiments described above, it is described that the plane in which the X axis and the Y axis are provided is orthogonal to the rotation axis O of the wheel rim 220, but the present disclosure is not limited thereto. The plane may intersect the rotation axis O without being orthogonal to the rotation axis O.

Further, in the third and fourth embodiments, it is described that the fastening state of the nut 240 is detected using the arctangent function, but the present disclosure is not limited thereto. The fastening state of the nut 240 may be detected by using an arcsine function (arcsin), an arccosine function (arccos), an arccotangent function (arccot), an arccosecant function (arccsc), and an arcsecant function (arcsec).

In the embodiments described above, the number of the sensor devices for one wheel rim 220 may be appropriately changed as long as the number is one or more.

In the fourth embodiment, it is described that the fastening state (the looseness) of the nut 240 is detected based on a change in the rotation angle of the nut 240, but the present disclosure is not limited thereto. The fastening state (the looseness) of the nut 240 may be detected based on a comparison between an amount of change in at least one of the X-axis normalized value and the Y-axis normalized value and a predetermined threshold value.

Further, in the fourth embodiment, it is described that the rotation angle of the nut 240 is detected based on both the X-axis normalized value and the Y-axis normalized value, but the present disclosure is not limited thereto. The fastening state (the amount of change in the rotation angle) of the nut 240 may be detected based on only one of the X-axis normalized value and the Y-axis normalized value.

In the first to fifth embodiments described above, the sensor device is provided in the nut 240, but the present disclosure is not limited thereto. The sensor device may be provided in a bolt (a bolt that is separate from the wheel hub). In this case, unlike the embodiments described above in which the wheel rim (the wheel) is fastened to the wheel hub by the wheel nut, the wheel rim is fastened to the wheel hub by the bolt. The bolt in this case is an example of a “fastening member” in the present disclosure.

Further, in the first to fifth embodiments, it is described that the fastening state of the nut 240 is detected by the signal processor provided in the sensor device, but the present disclosure is not limited thereto. For example, the detection value of the acceleration sensor 1 may be transmitted to an electronic control unit (ECU) provided in the vehicle 200 through the communication unit 3, and the ECU may detect the fastening state of the nut 240 based on the detection value. In this case, the ECU corresponds to a “detection device” in the present disclosure.

Further, in the first to fifth embodiments described above, it is described that the fastening state of the nut 240 is detected based on an average value of two accelerations acquired during one rotation period of the wheel rim 220, but the present disclosure is not limited thereto. The fastening state of the nut 240 may be detected based on an average value of an even number (such as 4, 6, 8) of accelerations other than two accelerations during one rotation period of the wheel rim 220. It should be noted that the smaller the number of times, the lower the possibility of a deviation to occur in the measurement position due to the rotation (the smaller the effect of the deviation), and thereby the fastening state of the nut 240 can be detected more accurately. In addition, the fastening state of the nut 240 may not be detected using the average value of two accelerations (even number of times) as in the first to fifth embodiments. In other words, the fastening state may be detected based on the acceleration (one time) acquired in each sensing.

The above-mentioned embodiments and the above-mentioned modifications may be appropriately combined as long as there is no technical inconsistency.

It should be understood that the embodiments disclosed herein are illustrative and non-restrictive in all respects. The scope of the present disclosure is defined not by the above description but by the claims, and is intended to include all modifications within the meaning and scope equivalent to the claims.

### Reference Signs List

1a: acceleration sensor (acceleration detection unit); 2, 12, 22, 32, 42: signal processor (state detection unit); 2c, 12c, 22c, 32c: fastening state detection unit; 2d: acquisition unit; 42c: state determination unit (fastening state detection unit); 100, 300, 400, 500, 600: sensor device (detection device); 220: wheel rim (rotating body); 240, 340, 440, 540: nut (fastening member); 250a: wheel hub (fastened member) (vehicle body); O: rotation axis; X: axis (first axis); Y: axis (second axis).

1. A detection device comprising:
an acceleration detection unit that rotates in conjunction with rotation of a fastening member that fastens a fastened member to a rotating body, and detects an acceleration in at least one detection axis that intersects with a rotation axis of the rotating body; and
a state detection unit that detects a fastening state of the fastening member based on the acceleration detected by the acceleration detection unit.

2. The detection device of claim 1, wherein
the detection axis includes a plurality of detection axes, each of which intersects with the rotation axis.

3. The detection device according to claim 2, wherein
the plurality of detection axes include the a first axis and a second axis that intersects with the first axis in a plane intersecting with the rotation axis.

4. The detection device according to claim 1, wherein
the state detection unit detects the fastening state of the fastening member based on the acceleration detected by the acceleration detection unit and a centrifugal acceleration applied to the rotating body.

5. The detection device according to claim 3, wherein
the state detection unit detects the fastening state of the fastening member based on an acceleration index that indicates a ratio between a first axis acceleration which is an acceleration in the first axis detected by the acceleration detection unit and a second axis acceleration which is an acceleration in the second axis detected by the acceleration detection unit.

6. The detection device according to claim 5, wherein
the acceleration index includes at least one of a first axis normalized value obtained by normalizing the first axis acceleration and a second axis normalized value obtained by normalizing the second axis acceleration.

7. The detection device according to claim 1, wherein
the state detection unit determines that the fastening state of the fastening member has changed when a positive or negative sign of the acceleration detected by the acceleration detection unit is reversed.

8. The detection device according to claim 1, wherein
the acceleration detection unit detects an acceleration every predetermined period,
the state detection unit determines whether or not the rotation of the rotating body is stopped, and
upon determining that the rotation of the rotating body is stopped, the state detection unit sets the predetermined period longer than that set when the rotating body is rotating.

9. The detection device according to claim 1, wherein
the acceleration detection unit is provided in a nut that fixes a wheel rim to a vehicle body.

10. The detection device according to claim 1, wherein
the state detection unit acquires information on the acceleration every predetermined period so as to acquire the information on accelerations detected by the acceleration detection unit for an even number of times during one rotation period of the rotating body, and detects the fastening state of the fastening member based on an average value of the accelerations acquired at the even number of times or an average value of angles of the fastening member calculated respectively from the accelerations acquired at the even number of times.

11. The detection device according to claim 10, wherein
the state detection unit detects the fastening state of the fastening member when the centrifugal acceleration applied to the rotating body is equal to or greater than a predetermined value, and acquires the information on the acceleration every predetermined period based on a rotation speed of the rotating body corresponding to the predetermined value.

12. A state detection device that detects a fastening state of a fastening member based on an acceleration detected by an acceleration detection unit that rotates in conjunction with rotation of the fastening member that fastens a fastened member to a rotating body, the state detection device comprising:
an acquisition unit that acquires information based on the acceleration in a detection axis that intersects with a rotation axis of the rotating body; and
a fastening state detection unit that detects the fastening state of the fastening member based on the information acquired by the acquisition unit.

13. A detection method of a detection device that includes an acceleration detection unit that rotates in conjunction with rotation of a fastening member that fastens a fastened member to a rotating body, the detection method comprising:
detecting, by the acceleration detection unit, an acceleration in a detection axis that intersects with a rotation axis of the rotating body; and
detecting a fastening state of the fastening member based on the acceleration detected by the acceleration detection unit.
